(19) United States
(12) Patent Application Publication
(10) Pub. No.: US 2018/0368940 A1
(43) Pub. Date: Dec. 27, 2018

(54) DENTAL INSTRUMENT FOR RESTORATIVE PROCEDURES

(71) Applicants: Stuart Jeffrey Katz, New Westminster (CA); Mohssen Behrad, Burnaby (CA)

(72) Inventors: Stuart Jeffrey Katz, New Westminster (CA); Mohssen Behrad, Burnaby (CA)

(73) Assignee: Stuart Jeffrey Katz, New Westminster (CA)

(21) Appl. No.: 16/118,331

(22) Filed: Aug. 30, 2018

Related U.S. Application Data
(63) Continuation-in-part of application No. PCT/IB2017/000244, filed on Feb. 23, 2017.
(60) Provisional application No. 62/298,679, filed on Feb. 23, 2016.

(51) Int. Cl. A61C 5/85

(52) U.S. Cl. CPC A61C 5/85

(57) ABSTRACT

This invention presents “respect” for the adjacent tooth by providing an instrument and method that presses the matrix band against the adjacent tooth, and presents inventive examples of the concave shape of its prongs (to match the convex contour of the adjacent tooth) and the hinged couplings that translate well the clinician's personal efforts to press against the adjacent tooth in what are otherwise, awkward ergonomic angles. By moving the mechanical levers of his own body more proximate the treated tooth and by using a stabilizing arm that establishes a fulcra point of stability in the tooth adjacent to the treated tooth, the clinician can better achieve the objectives of good physiologic fit of the matrix band with the adjacent tooth.

### RELATION TO PREVIOUS APPLICATION

This application claims priority to PCT application no. PCT/IB2017/000244 (filed Feb. 23, 2017), and to U.S. provisional application No. 62/298,679 (filed Feb. 23, 2016), the entire disclosures of which are incorporated by reference herein.

### FIELD OF THE INVENTION

The field of the invention is dental instruments.

### BACKGROUND

The background description includes information that may be useful in understanding the present invention. It is not an admission that any of the information provided herein is prior art or relevant to the claimed invention, or that any publication specifically or implicitly referenced is prior art.

Tooth decay, also known as dental caries, is an oral disease that affects many people. When treating decay, recreating the anatomy of the damaged tooth, after the removal of the decay, is crucial not just to restore tooth form, but also to re-establish function. This is usually done by removing the affected portion of the tooth and restoring the prepared tooth with restorative materials. Based on the tooth type, location and tooth surfaces, restorations can be classified into classes I through V. Of these, Class II restorations involve the proximal surfaces of teeth, and pose unique challenges to restorative dentists. Normally, adjacent healthy teeth are in proximal contact with each other. However, this interproximal contact is lost when interproximal decay is removed. The challenge in Class II restorative techniques is to re-establish good physiologic, interproximal contact and a well-sealed gingival margin devoid of gaps or overhangs.

In conventional practice, interproximal decay is filled utilizing a matrix band. A matrix band acts as a form that holds dental restorative materials within the cavity preparation (commonly called the “proximal box”) of the tooth being restored. To hold a matrix bands in place, a wedge is placed in the interproximal space between the matrix band and the adjacent tooth. Wedges acts to both force the adjacent teeth apart and to force the matrix band against the tooth being restored (“treated tooth”) to achieve isolation from blood, saliva, and crevicular fluids.

In the case of sectional matrix bands, ring-clamps are used with wedges. They serve to adapt the matrix band to the coronal aspect of the tooth being restored. They also act by holding the matrix band against the proximal surface of the adjacent tooth while slightly forcing the teeth apart. The ring-clamps could be placed either after or before the wedge depending on the system. As well, the matrix band can be burnished against the surface of the adjacent tooth with which the contact is to be formed. Once the matrix, wedge, and/or ring-clamps are in place, the tooth is primed for restoration.

Traditional matrix band holders (such as “Tofflemire” matrix band retainers), allow the matrix band to be tightened around the tooth being restored. As such they provide predictable isolation even in more difficult situations; however, the contact pressure is often weak when they are used to place composite restorations. Because of the difficulties in establishing predictable proximal contact when placing composites with Tofflemire matrix bands, various sectional matrix bands and rings-clamp systems have been developed to address achieving predictable proximal contact. These systems can be time-consuming to place, expensive, and do not achieve the degree of predictable isolation that Tofflemires bands do.

To enhance proximal contact, numerous hand instruments have been developed to push matrix bands against the proximal surfaces of adjacent teeth. These instruments can be used with both sectional and Tofflemire matrix bands.

In one technique, a condenser or OptraContact®-type instrument is used to displace the restorative material in a gingival direction while pushing the matrix band against the proximal surface of the adjacent tooth. This acts to enhance the contact pressure by extending the proximal dimension of the restoration. When the first layer of composite is cured with the instrument in place, a “contact bridge” of composite material, is formed. The instrument is then removed and the resulting holes are filled with a flowable composite.

One problem with the dental instruments like OptraContact® is that the stabilization of the instrument is usually achieved by the clinician's finger rest or fulcrum on a tooth that is more forward (i.e. anterior) of the treated tooth in the dental arch, and is often a front tooth. As this fulcrum is relatively far from the point of proximal surface contact of the treated tooth, there is inherent positional instability of the working end tool portion of the instrument. Without adequate stabilization, a loading force may be exerted by the clinician (e.g., dentist, dental assistant, et al), operating in ergonomically awkward position, in a slightly incorrect direction, or against the wrong part of the matrix band. As such, the effectiveness of the instrument is compromised.

The prior art appears to be focused on handling the treated tooth and seems oblivious (in paying no “respect”) to the adjacent tooth. Dryer (US publication 2004/0142303) discloses members which are curved or angled to match the curvature of the treated tooth, not the adjacent tooth. Slone (U.S. Pat. Nos. 6,280,187 and 5,318,446) are for explicitly convex interaction with adjacent concave tooth and are thus geometrically unfit for each other. Similarly Stasiak (U.S. Pat. No. 6,261,095) teaches a strut that is “generally symmetrically conical”, again, the focus is on the geometry of the treated tooth and not the adjacent tooth. Meinershagen (U.S. Pat. No. 4,836,781) is a post-restoration invention for amalgam restoration (not composite) where two teeth are restored (hence two bands), which explains why the bifurcated ends of its instrument terminate at the same distance relative to the occlusal plane; and in any case, it is focused on keeping the amalgam from being frictionally dislodged and carried upwardly by the surface of the two bands as they are being removed. Hoffman (U.S. Pat. No. 5,788,499) does reference the adjacent tooth but its teaching locates force being applied proximate the gum of the adjacent tooth, which is dangerous to the gum, instead of the present invention's use of the occlusal surface of the adjacent tooth.

Inadequate proximal contact can result in initiating food impactions and plaque accumulation, that can damage interproximal tissue and lead to recurring decay. Improper isolation can result in improper bonding and overhanging restorations that can lead to gingival irritation and post-operative sensitivity and recurrent decay. Hence, there is a need for dental instruments and restorative procedures that can predictably achieve adequate proximal contact pressure and gingival isolation while placing class II composite restorations.

If a dental instrument were to achieve predictably adequate proximal surface contact pressure in class II composite restorations using Tofflemire matrix bands that are easier to place, achieve more predictable isolation, and are less expensive than sectional matrix bands, then such an instrument would be widely adopted.

Thus, there remains a need for improved dental instruments for restorative procedures.

### SUMMARY OF THE INVENTION

A key to success in class II restorations is to establish good physiologic contact between the restored tooth and its adjacent tooth. This invention recognizes that the proximal surface of the adjacent tooth has a quasi-bulbous, generally convex profile and so provides a device and method to assist the dentist to conform the matrix band as closely as possible to such adjacent tooth convex profile. In summary (and as elaborated below), this invention presents “respect” for the adjacent tooth by providing an instrument and method that presses the matrix band against the adjacent tooth, with inventive features such as the concave shape of its abutment prongs (to match the convex contour of the adjacent tooth) and the hinged couplings that translate well the clinician's personal efforts to press against the adjacent tooth in what are otherwise, awkward ergonomic angles. By moving the mechanical levers of his own body more proximate the treated tooth, and in particular, without limiting the generality of the preceding, by the use of a stabilizing arm that establishes a fulcra point of stability on the tooth adjacent to the treated tooth, the clinician can better achieve the objectives of good physiologic fit of the matrix band with the adjacent tooth.

The present invention provides apparatus, systems, and methods in which a dental restorative instrument has a stabilizing arm that allows for a controlled and strategically applied pressure during a dental restorative procedure that results in a predictably reinforced contact pressure. The dental instrument features an elongated member that has a handle portion and a tool portion. The tool portion has a condenser for packing restorative composite material. The condenser extends from an end of the elongated member and preferably comprises two prongs or legs that are separated by a space. The dental instrument also has a stabilizing arm extending from the tool portion beyond the condenser prongs and over the marginal ridge of the adjacent tooth, to rest (adjustably) on the occlusal surface thereof. The stabilizing arms may also extend from the condenser prongs at right angles.

The prongs of the condenser tool are used to condense or pack a restorative material (e.g., packable or flowable composite, or certain plastics, such as glass ionomer, that sets in the mouth) into a cavity preparation. The condenser is also used to press outward against a matrix band to increase the contact pressure of proximal wall of the restoration against the adjacent tooth. More specifically, the space between the prongs allows the restorative material to flow between the prongs and outward against the matrix band as the prongs are pushed against the matrix band against the proximal surface of the adjacent tooth. The prongs are slightly curved concavely to maximize contact with the convex proximal surface of the adjacent tooth. The prongs are tapered vertically to facilitate removal from the hardening composite.

In one aspect of some embodiments, the tool portion of the dental instrument can be movably coupled with the elongated member at a (conventional) flexible and/or rotatable coupling. This allows for more stable and strategic orientation of the prongs against the adjacent tooth. The tips of the prongs should extend just apical or gingival to the height of contour of the adjacent tooth. Should the initial pushing force not be correctly applied at right angles to the proximal surface of the adjacent tooth, the flexible coupling would allow for correction and a resultant force that is applied at right angles to the adjacent tooth. There is also a coupling mechanism to allow the clinician to adjust the position and/or orientation of the tool portion relative to the handle portion to treat upper and lower teeth from different working angles.

In another aspect of some embodiments, the stabilizing arm has an adjustable vertical length relative to the occlusal plane. By adjusting the (vertical) length that the stabilizing arm extends, the clinician can influence (as elaborated below) the depth of the prongs against the adjacent tooth (because the stabilizing arm is connected to the prongs in respect of vertical distance—the prongs and stabilizing arm move in adjustable coordination relative to the occlusal plane). Prongs would require adjustment when teeth of varying clinical heights are being restored.

In yet another aspect of embodiments, the distance between the prongs could be adjusted by turning a screw that would effect movement of the prongs towards or away from each other. The (final) separation of the prongs represents the limits of the contact area being formed. Prong separation would be adjusted with the various buccolingual dimensions of the teeth being restored.

From a method perspective, the present invention provides apparatus, systems, and methods in which a restorative composite material is placed in a cavity of a tooth (specifically, the cavity preparation or proximal box) using a dental instrument. The method comprises the steps of: (i) placing a matrix band around the prepared proximal surface of the tooth (as with a Tofflemire matrix band holder) or a sectional matrix band between the prepared tooth and the adjacent tooth; (ii) wedging the matrix in place; (iii) placing a restorative material inside the cavity preparation; (iv) pushing the condenser tool down on the restorative material on the occlusal surface of the tooth such that at least some of the restorative material occupies the space between the prongs of the condenser; (v) placing the stabilizing arm against an appropriate structure of the adjacent tooth to facilitate stabilization of the instrument; (vi) pushing the condenser tool against the matrix band to extend the proximal dimension of the restorative material; and (vii) allowing the restorative material to solidify. In some embodiments, the method can further comprise the step of adjusting the length of the stabilization arm prior to placing the stabilizing arm against an appropriate structure of the adjacent tooth, its occlusal surface being a stable location (and in particular, the central groove is an ideal location to establish a fulcra-point). On its occlusal surface. In other embodiments, various sizes of condensers can be chosen in accordance the size of contact area needed.

One should appreciate that the disclosed subject matter provides many advantageous technical effects including providing a stabilizing arm on a dental restorative instrument for better control of applied pressure. The instruments and their methods of use as described herein also facilitate creating predictable proximal contact between adjacent teeth during a dental restorative procedure.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a perspective view of one embodiment of a dental instrument for restorative procedures.

FIG. 2 is a perspective view of another embodiment of a dental instrument for restorative procedures. The instrument contacts a treated tooth and an adjacent tooth.

FIG. 3 is a perspective view of another embodiment of a dental instrument for mesial proximal tooth restorations.

FIG. 4 is a perspective of a variation of the embodiment of FIG. 3.

FIG. 5 is a perspective view of a single dental instrument with tools at opposed ends for distal and mesial restorations.

FIG. 6 are front and top views of linkage of two prongs with the single stabilizing arm. As can be seen, conventional joints interact two prongs 605 with the single stabilizing arm 604, so that adjustment of the lateral separation between prongs 605 result in the movement anteriorly or posteriorly of stabilizing arm 604, ideally along central groove of the adjacent tooth, and thus still provides the instrument a stable fulcrum at the adjacent tooth.

FIG. 7 are front and top views of linkage of two prongs with the single stabilizing arm. Rectangular sliding bracket or frame 710 is sized to permit relatively free horizontal movement of prongs 705 with respect to each other within the boundaries of frame 710; however, one prong, 705a is rigidly attached to one end of frame 710, and thereby rigidly stabilizes stabilizing arm/pin 704 (which pin ultimately rests under translated manual force) on the occlusal surface of the adjacent tooth).

FIG. 8 are four perspective views of the instrument for distal restoration, viewed from underneath.

FIG. 9 are a transparent version of the views of FIG. 8.

FIG. 10(a) are four views of the instrument for distal restoration.

FIG. 10(b) are an enlarged version of FIG. 10(a).

FIG. 11(a) are a transparent version of the views of FIG. 10(a).

FIG. 11(b) are an enlarged version of FIG. 11(a).

FIG. 12 are four views of the instrument for mesial restoration.

FIG. 13 are a transparent version of the views of FIG. 12.

FIG. 14 are four alternate views of the instrument of FIG. 12.

FIG. 15 are a transparent version of FIG. 14.

FIG. 16 are a more detailed version of FIG. 14.

FIG. 17 are alternative views of FIG. 14.

FIG. 18 is a transparent view of one view of FIG. 17, showing the hinge within handle.

FIG. 19 is a more detailed view of the internal hinge of FIG. 18.

FIG. 20 are six views of an instrument adapted for both mesial and distal restorations.

FIGS. 21(a), 21(b), 21(c) are side views of the multi-dimensionally adjustable embodiment of the stabilizing arm using a slotted sled;

FIG. 22 is several perspective views of an instrument for distal restoration, using the arm of FIG. 21;

FIGS. 23(a), 23(b) are two side views of the instrument of FIG. 22;

FIGS. 24(a), 24(b) are two perspective views (from above) of the instrument of FIG. 22;

FIG. 25 is the bottom view of the of the instrument of FIG. 22;

FIG. 26 is an axial view of the instrument of FIG. 22 viewed from the distal end towards the handle end;

FIG. 27 is several perspective views of an instrument for mesial restoration, using the arm of FIG. 21;

FIG. 28(a), 28(b) are two side views of the instrument of FIG. 27;

FIG. 29(a), 29(b) are two perspective views (from below) of the instrument of FIG. 27;

FIG. 30 is the bottom view of the instrument of the instrument of FIG. 27; and

FIG. 31 is an axial view of the instrument of FIG. 27 viewed from the distal end towards the handle end.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

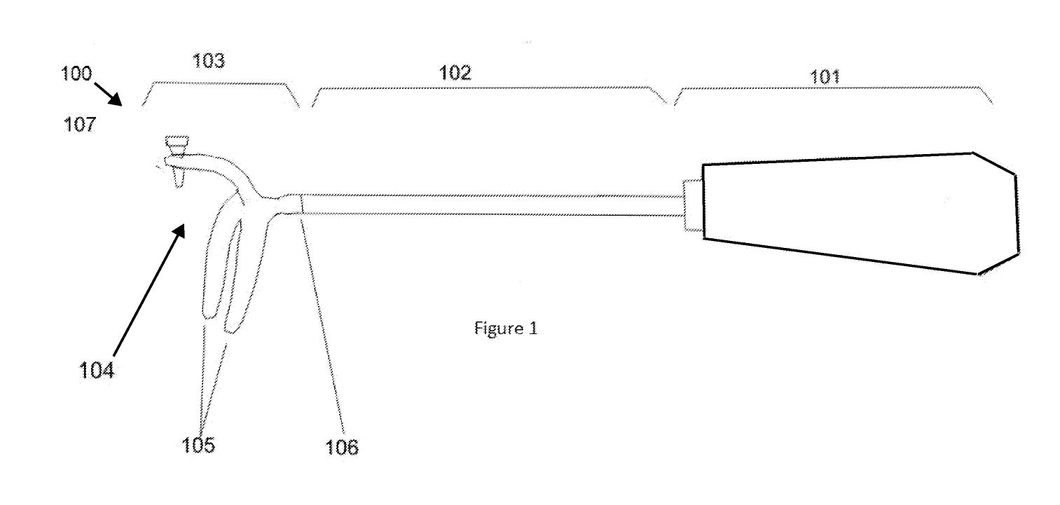

FIG. 1 shows a perspective view of dental restorative instrument 100. Instrument 100 is an elongated member with handle portion 101, middle portion 102, and condenser/tool portion 103. Handle portion 101 and condenser/tool portion 103 are located on opposite ends of the elongated member middle portion 102. Instrument 100 is used for placing restorative material in a cavity preparation of a tooth. The cavity preparation is located on at least a portion of a proximal surface of the treated tooth, wherein the proximal surface abuts an adjacent tooth.

Condenser/tool portion 103 extends from an end of the elongated member middle portion 102 and has two prongs (or legs, tines or is a bifurcated end) 105 that are separated by a space. Condenser/tool portion 103 is used to pack, move, and/or manipulate a restorative material in the cavity preparation. Condenser portion 103 is also used to expand (e.g., push against and/or stretch) a barrier between the treated tooth and an adjacent tooth to create a restored proximal surface that provides proper proximal contact with the adjacent tooth. The barrier can be a matrix band or any other structure configured to shape and/or hold the restorative material within the cavity preparation.

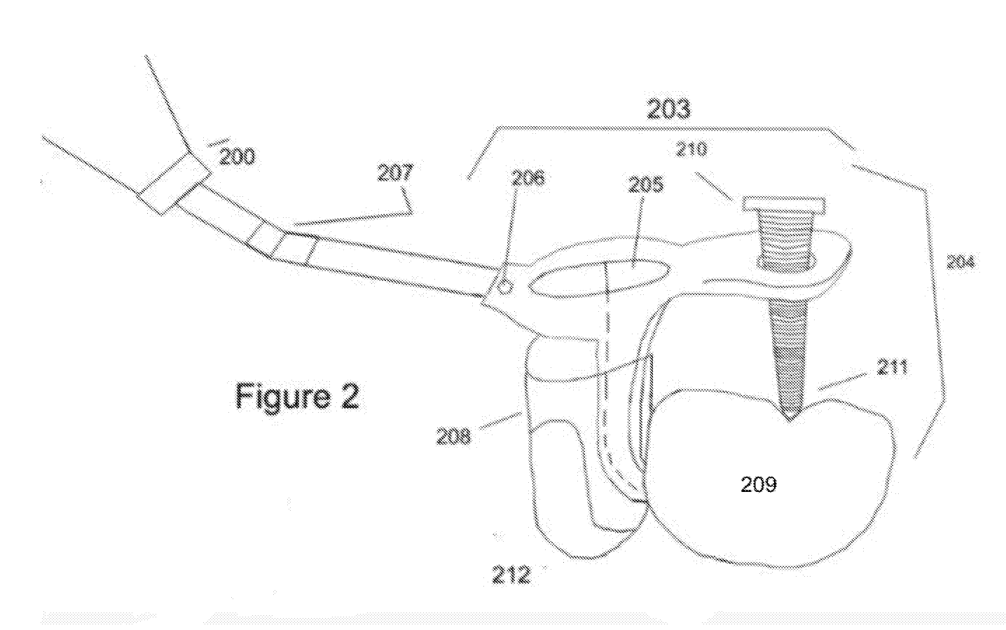

Condenser/tool portion 103 also has stabilizing arm 104 extending from the distal end of condenser/tool portion 103. Arm 104 is sized, dimensioned, and positioned so as to rest on the occlusal surface of the adjacent tooth when prongs 105 are in the cavity preparation. Arm 104 helps the clinician to stabilize instrument 100 during the dental restoration process. Arm 104 preferably has an adjustable length or separation relative to the occlusal surface of the adjacent tooth. For example, arm 104 can comprise pin 210 (first illustrated in FIG. 2) that is threadably coupled (e.g. with a conventional screw mechanism) with condenser/tool portion 103 such that turning pin 210 clockwise will shorten pin 210 relative to the remainder of arm 104 when placed on the occlusal surface of the adjacent tooth, whereas turning the pin counter-clockwise will lengthen pin 210. It is also contemplated that the pin length could be adjusted by turning handle portion 101 in a conventional (gear and coupling) mechanism that transfers rotation of handle portion 101 to rotation of stabilizing arm pin. Herein, references to “stabilizing arm” includes its pin, unless particular emphasis on the pin is intended, and is the component that rests on the occlusal surface of the adjacent tooth and is used as a fulcra point for the instrument's prongs to abut the matrix band against the buccal-lingual surface of the adjacent tooth.

Stabilizing arm 104 is disposed to rest against the occlusal surface of the adjacent tooth and the prongs are disposed to approach the floor of the cavity preparation or proximal box of the treated tooth, which by definition is farther away from the occlusal plane because the proximal box floor was created by drilling tooth structure in a gingival direction to remove the decay.

Condenser/tool portion 103 is coupled with middle portion 102 of the elongated member at flexible/rotatable coupling 106. Coupling 106 allows the condenser/tool portion 103 to move relative to the elongated member. This allows the clinician to adjust the orientation and/or position of condenser/tool portion 103 to work on different teeth (e.g., upper teeth, lower teeth, mesial proximal surfaces, distal proximal surfaces). Coupling 106 can be configured to allow condenser/tool portion 103 to bend at different angles, rotate, and/or extend farther out (e.g., telescopically extending). Coupling 106 preferably has a locking feature that allows the clinician to lock condenser/tool portion 103 in place as needed. In some embodiments, it is contemplated that turning handle portion 101 can adjust the position/orientation of condenser/tool portion 103. In addition, pulling/pushing handle portion 101 could actuate the locking and unlocking of condenser/tool portion 103.

FIG. 2 shows a dental restorative instrument 200. Instrument 200 is functionally similar to instrument 100 in some aspects. However, unlike instrument 100, instrument 200 has angle joint 207 which is approximately 150 degrees but can be adjusted as needed (e.g., acute, obtuse, etc.). The selected angle can help to improve access to certain teeth in the patient's mouth depending on the clinician's work angle (e.g., behind the patient's head, in front of the patient's head, to the side of the patient's head, etc.).

Prongs 205 are placed inside matrix band 208 and within cavity preparation or proximal box 212. Matrix band 208 (shown in FIG. 2 in transparent mode to view its content) surrounds the tooth (not shown in FIG. 2 for simplicity of illustration) to be treated and separates the treated tooth from adjacent tooth 209. Stabilizing arm 204 (with its threaded pin 210) rests on occlusal surface of adjacent tooth 209 (and in particular, its pin apical tip 211 fulcrumed in the central groove of adjacent tooth 209). Flexible coupling 206 has been adjusted to properly orient and locate condenser/tool portion 203.

Prongs 205 are laterally separated by a distance. The distance is dimensioned to fit inside matrix band 208 mid inside the cavity preparation or proximal box. In some instances (depending on the size of teeth, size and shape of proximal box), the lateral separation between the first prong and second prong is less than 5 mm, and could be even less than 3 mm. The overall width of condenser tool 203 is also less than the width of the cavity in the treated tooth.

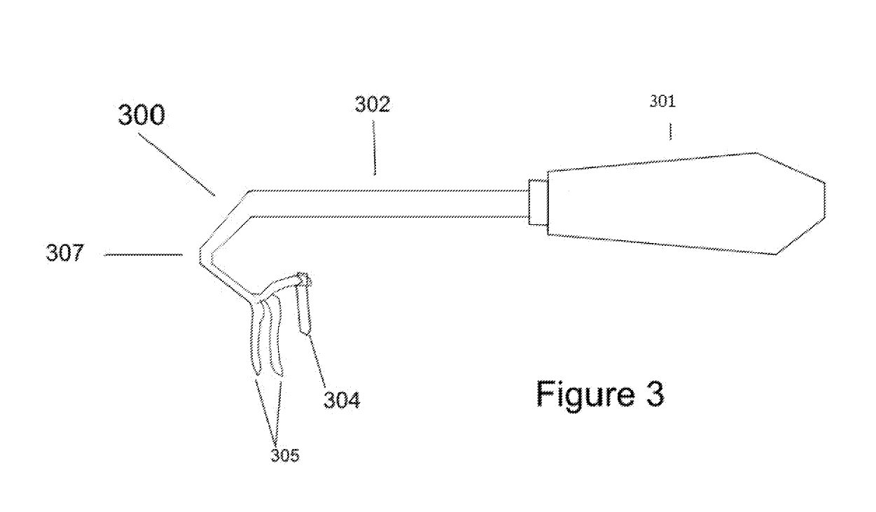

FIG. 3 shows yet another dental restorative instrument 300. Instrument 300 is similar to instrument 200 in many aspects. For example, instrument 300 has handle portion 301, middle portion 302, and condenser/tool portion 303 (comprising two prongs 305 and stabilization arm 304). However, instrument 300 is different in that middle portion 302 has an acute angle 307. Angle 307 causes condenser/tool portion 303 to face handle portion 301. This orientation allows the clinical to work on mesial proximal surfaces (e.g., proximal surfaces that are facing the midline or mouth opening).

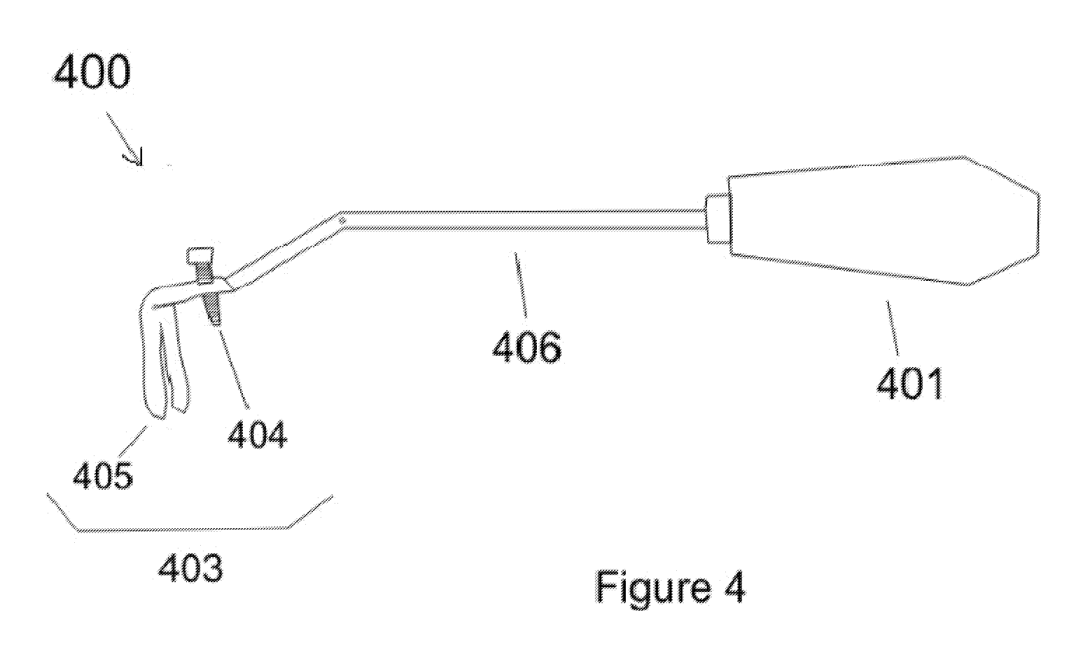

For mesial restoration, the embodiment of FIG. 3 shows the tool portion (with stabilizing arm 304 and prongs 305 being identical or very similar to their corresponding components in FIGS. 1 and 2 for distal restoration) being turned around to face mesially the mouth opening and the clinician, and with connection between tool portion and handle, as turning around toward the clinician and the opening of the mouth, to permit the clinician to pull on the instrument to press the tool portion on the adjacent tooth which is anterior of the treated tooth. FIG. 4 is a perspective of a variation of the embodiment of FIG. 3, wherein such connection is linear between tool portion and handle.

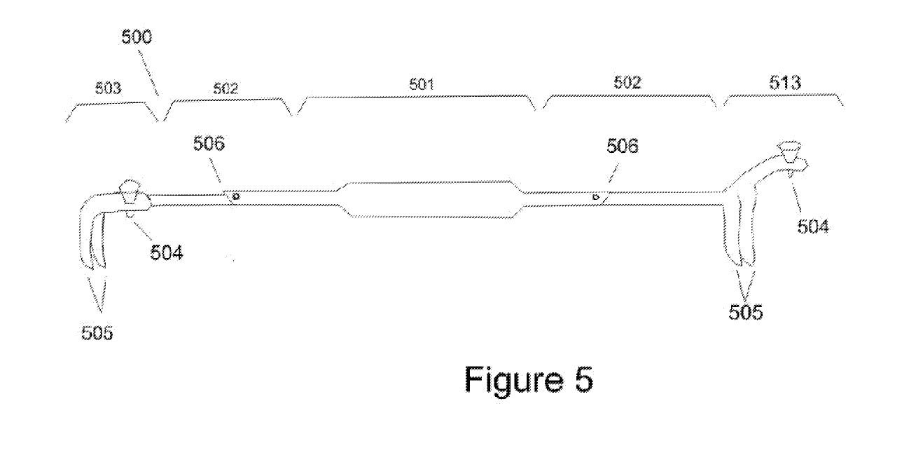

FIG. 5 is a perspective view of a single dental instrument 500 with tool portions 503 and 513 at opposed ends (for respectively, mesial and distal restorations) of central handle 501. In essence, the tool portions of FIGS. 1 and 4 are combined in a single instrument. Central handle 501 can have conventionally (not shown for simplicity of illustration) a trigger-like protrusion (to facilitate pulling by a finger), or an enlarged, bulbous central portion, and/or knurled surface or a series of concentric annular grooves or other friction-enhancing surface to assist the clinician to manipulate the instrument as desired.

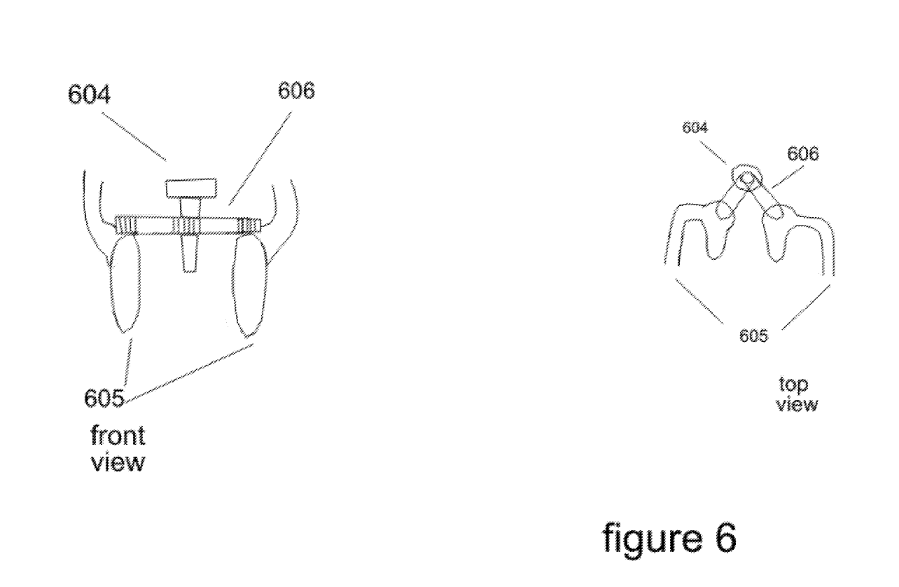

FIG. 6 are front and top views of linkage of two prongs 605 with single stabilizing arm 604. As can be seen, conventional joints interact two prongs 605 with the single stabilizing arm 604, so that adjustment of the lateral separation between prongs 605 result in the movement anteriorly or posteriorly of stabilizing arm 604, ideally along central groove of the adjacent tooth's occlusal surface, and thus still provides the instrument a stable fulcrum at the adjacent tooth.

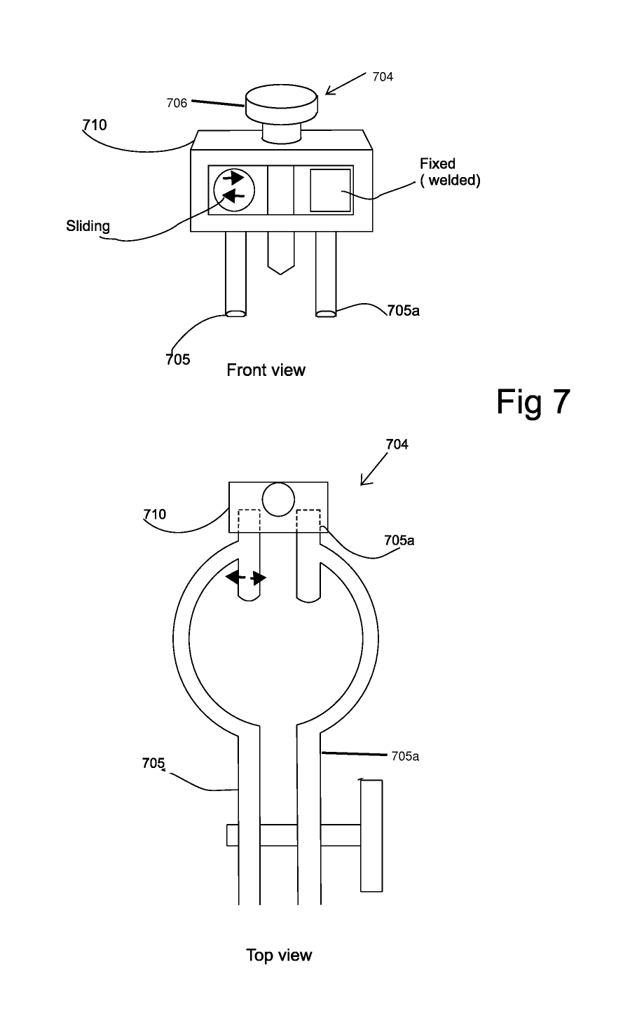

FIG. 7 are front and top views of linkage of two prongs 705 and 705a with single stabilizing arm/pin 704.

Rectangular sliding bracket or frame 710 is sized to permit relatively free horizontal movement of prongs 705 and 705a with respect to each other within the boundaries of frame 710 (i.e. laterally relative to the longitudinal axis of the instrument). Prongs 705 and 705a are identical except that distal end of prong 705a is rigidly attached to one end of frame 710 (as shown in FIG. 7), and thereby rigidly stabilizes stabilizing arm/pin 704 (which ultimately rests on the occlusal surface of the adjacent tooth).

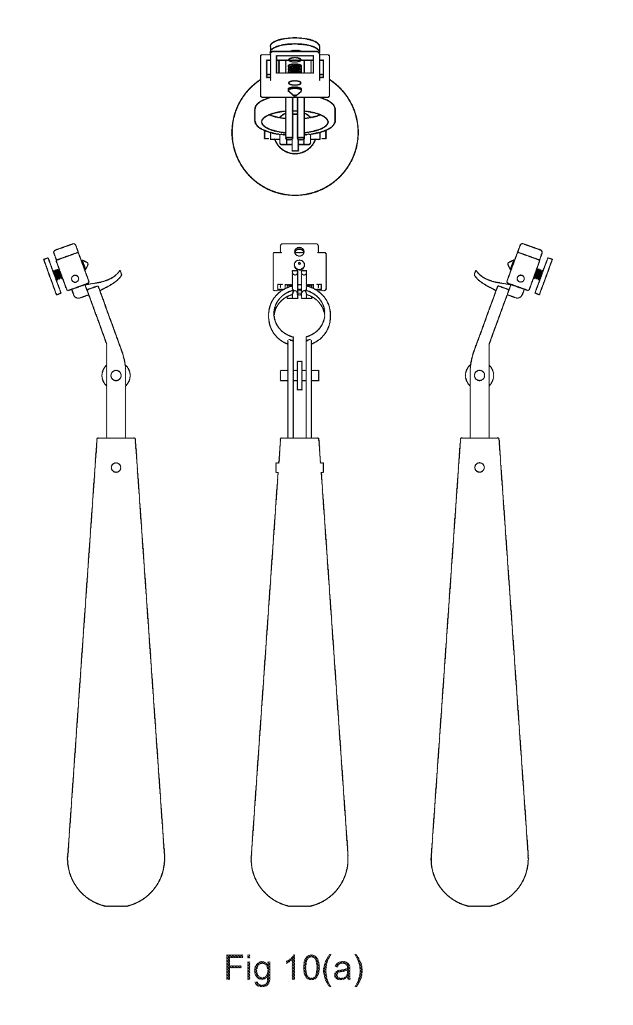

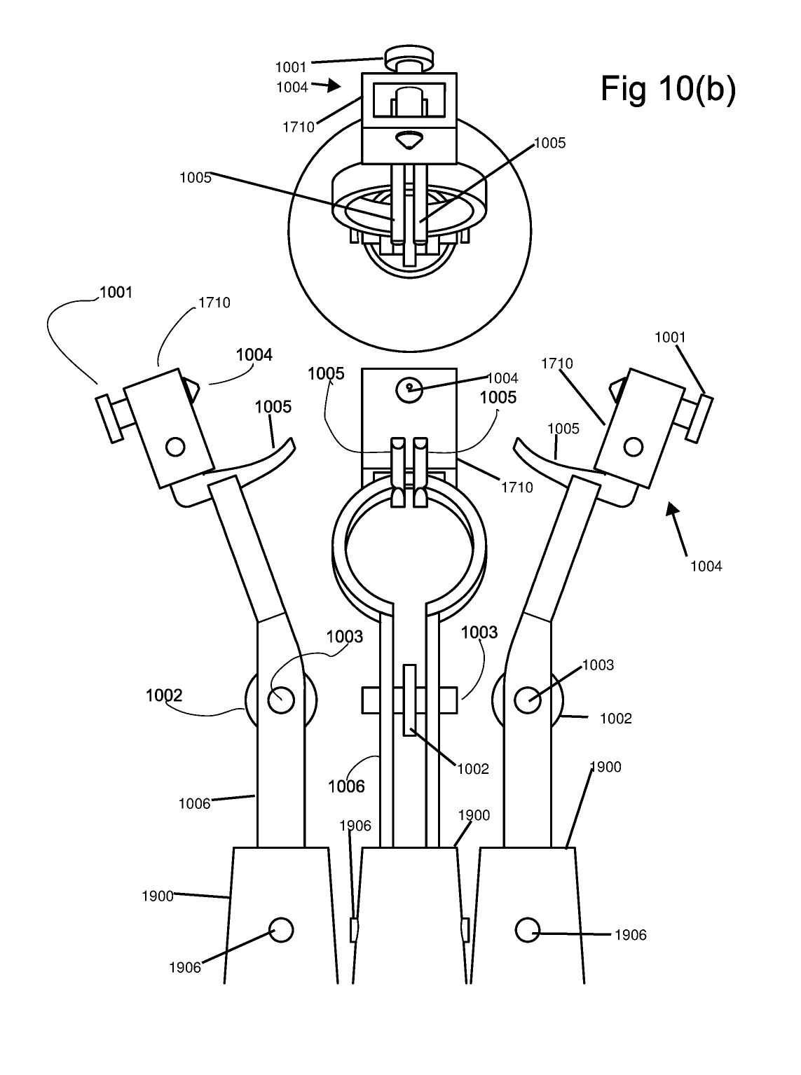

The instrument can be further equipped with finger pad 706 in vertical alignment with the stabilizing arm/pin 704. Finger pad 706 is a generally flat, area shaped to receive a pressed digit (e.g. of the dentist's hand which is not holding the instrument) and possibly coated with friction enhancing surface. As illustrated (first in FIG. 2 where the particular top of stabilizing arm pin 210 is flat), advantageously (but not necessary) fingerpad 706 may be a simple modification of the top of stabilizing arm pin 210, or may be the subject of a discrete extension of stabilizing arm/pin 704. In other illustrations and embodiments (e.g. FIGS. 7 and 10(b)), the top itself of bracket 710 or bracket 1710 may serve as a fingerpad.

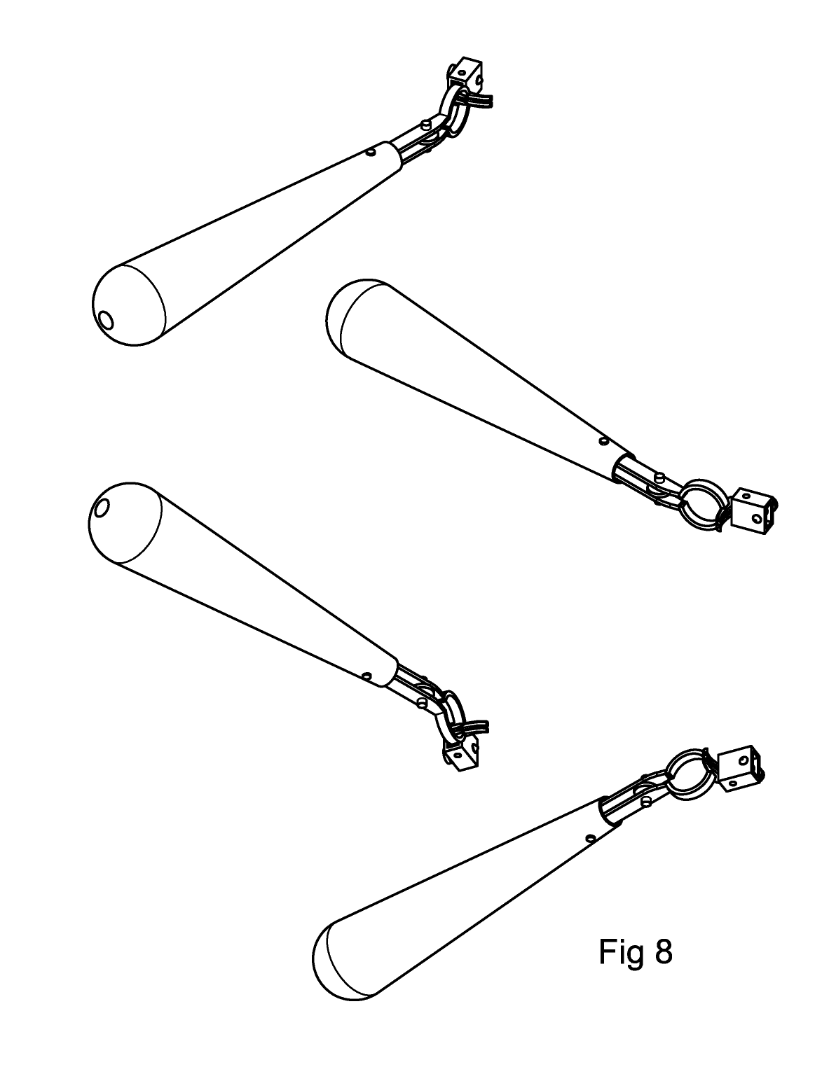

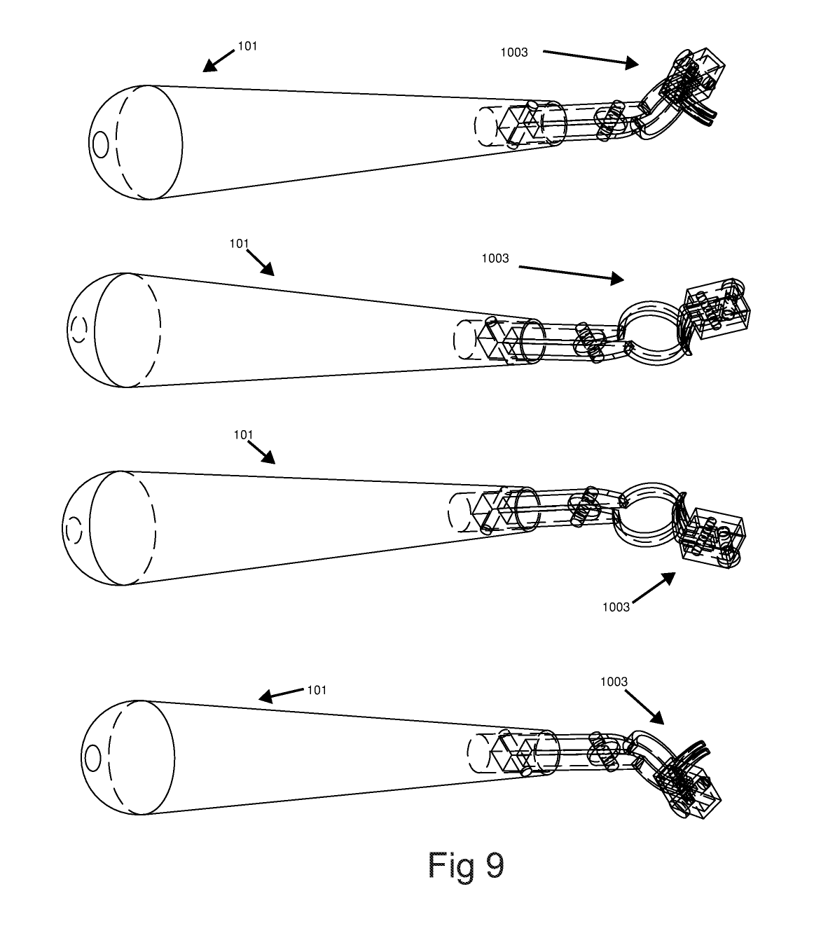

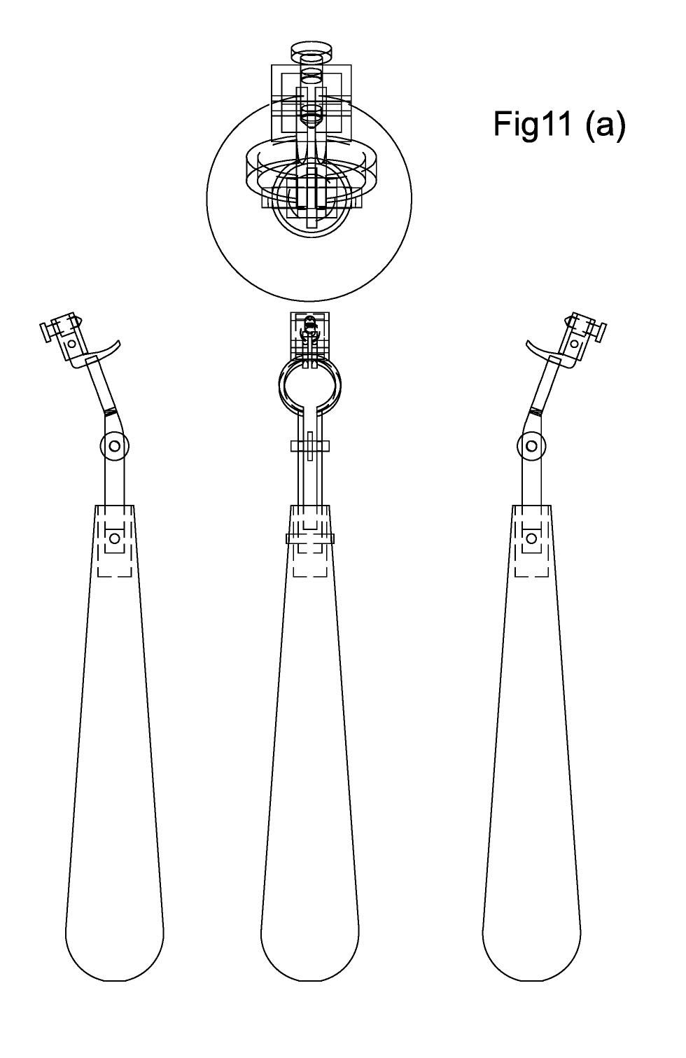

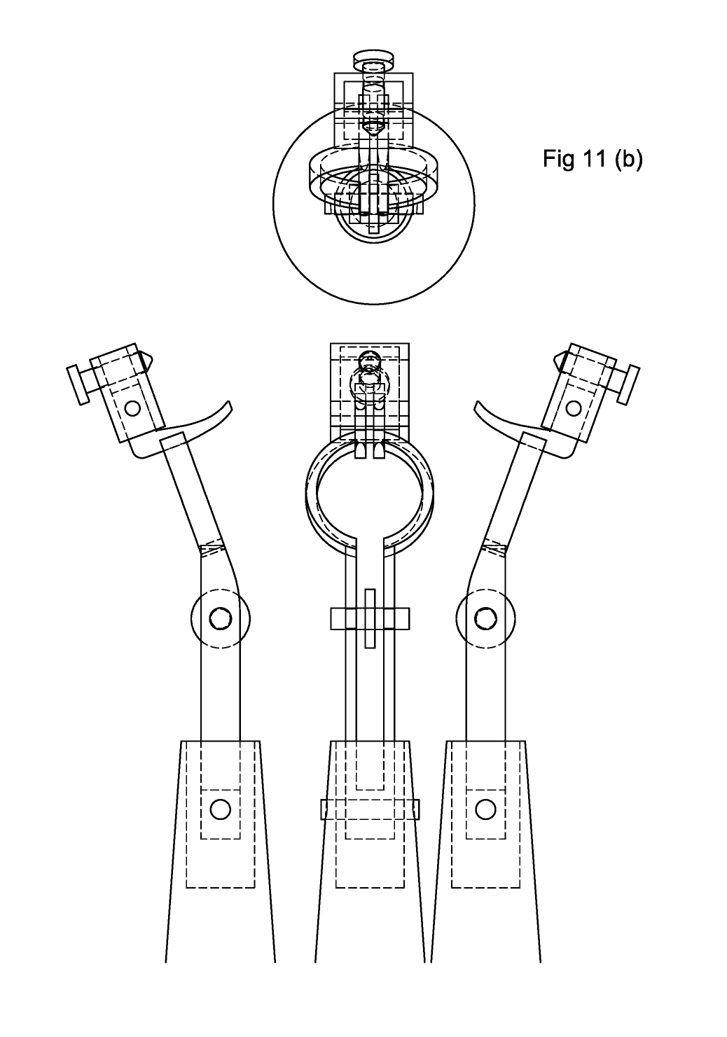

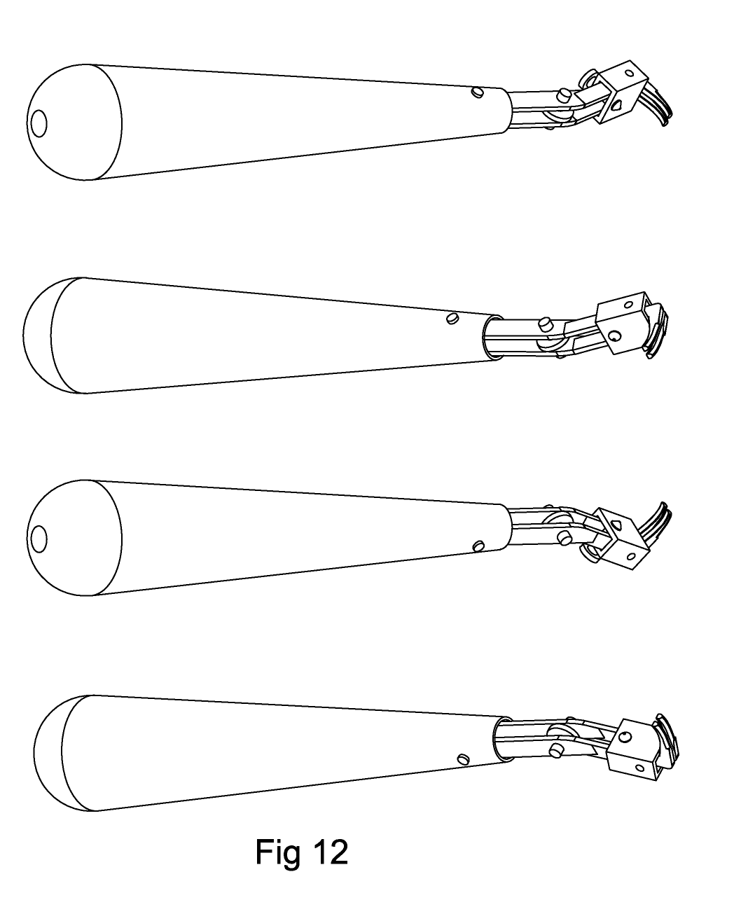

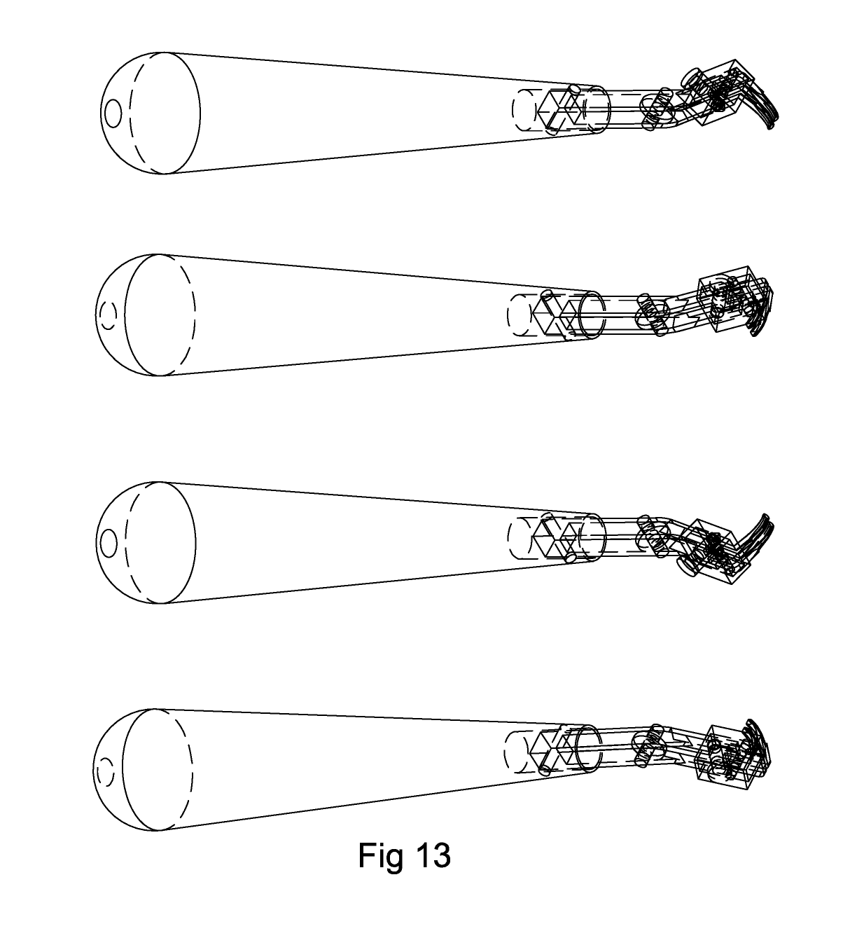

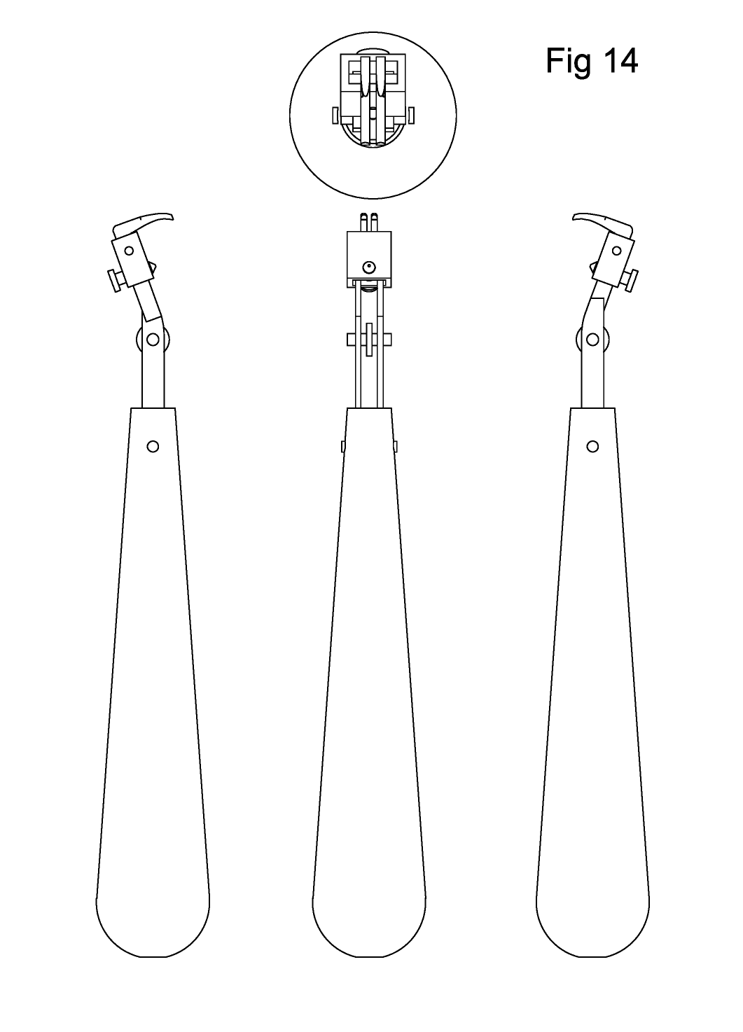

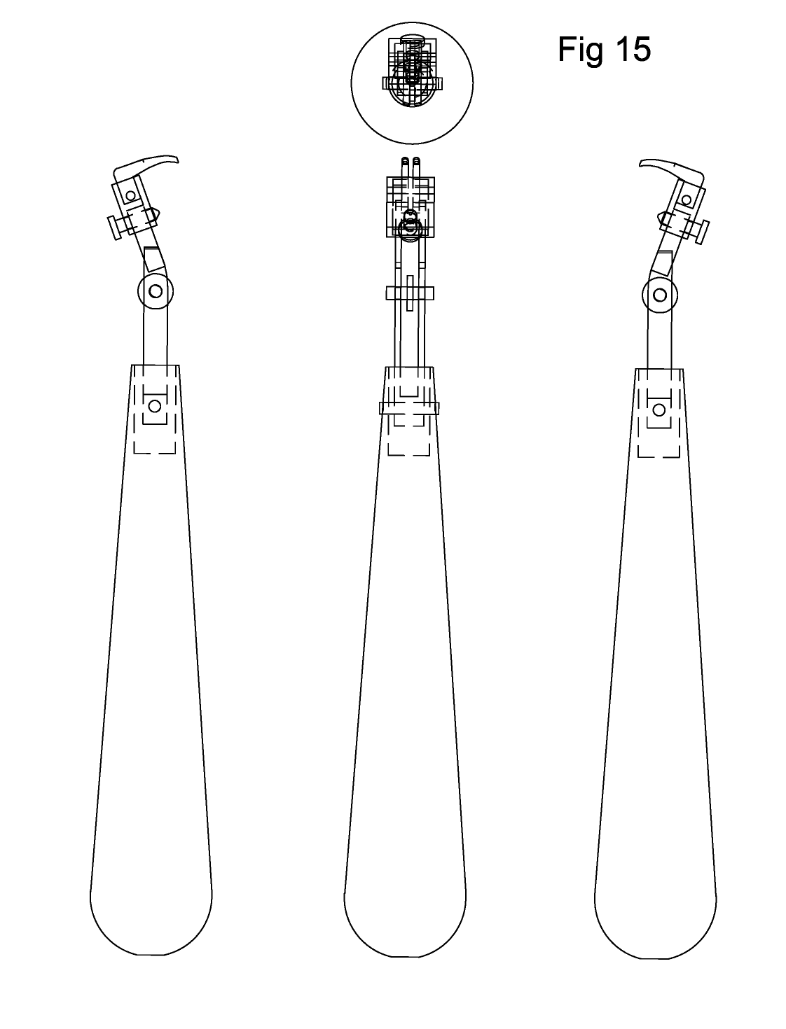

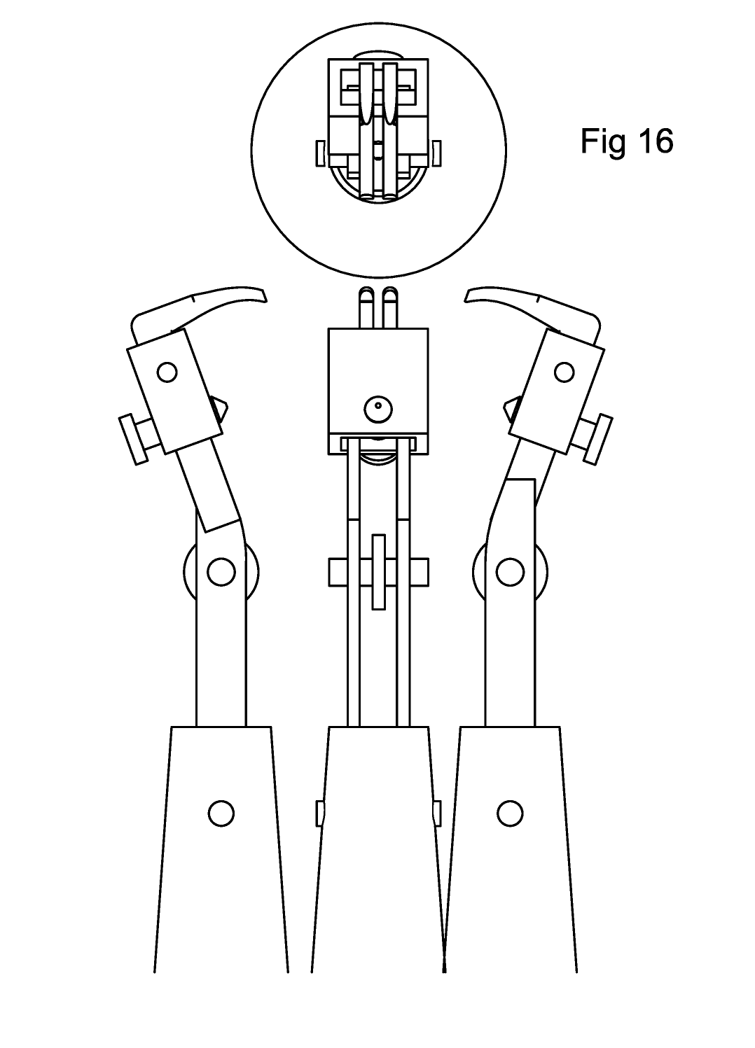

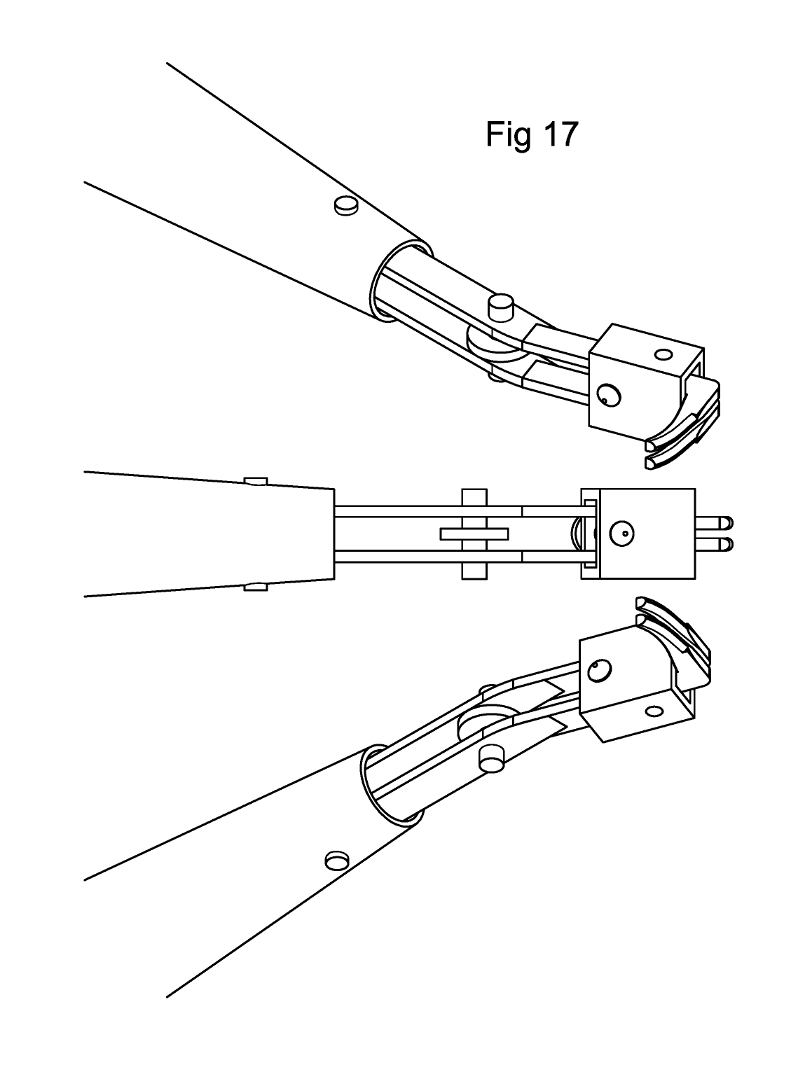

FIGS. 8 to 20 are implementations incorporating the inventive features explained above, directed to the mechanism whereby the prongs are adjustable separable. Similarly looking components in FIGS. 8-20 (whether identified by number or not) are the same as described in FIGS. 1-7. FIG. 10(b) is representative (for both mesial and distal restorations). Prongs 1005 are at the distal ends of respective extenders 1006 which connect to the handle (with an advantageous hinge mechanism, explained below). The separation between extenders 1006 (and thus prongs 1005) is adjustable by threaded knob 1002 rotating on mating pin 1003 which transverses extenders 1006. The clinician's thumb conveniently dials knob 1002 to effect the desired separation of prongs 1005 upon inspection of the environment of the treated tooth and in particular, of the proximal box. Stabilizing arm/pin 1004 is not only adjustable vertically (by conventional threaded means), but pin top 1001 also can serve as the “finger pad” for the clinician to press down on axially, thus stabilizing even more, stabilizing arm/pin 1004 onto the (ideally, central groove) of the occlusal surface of the adjacent tooth.

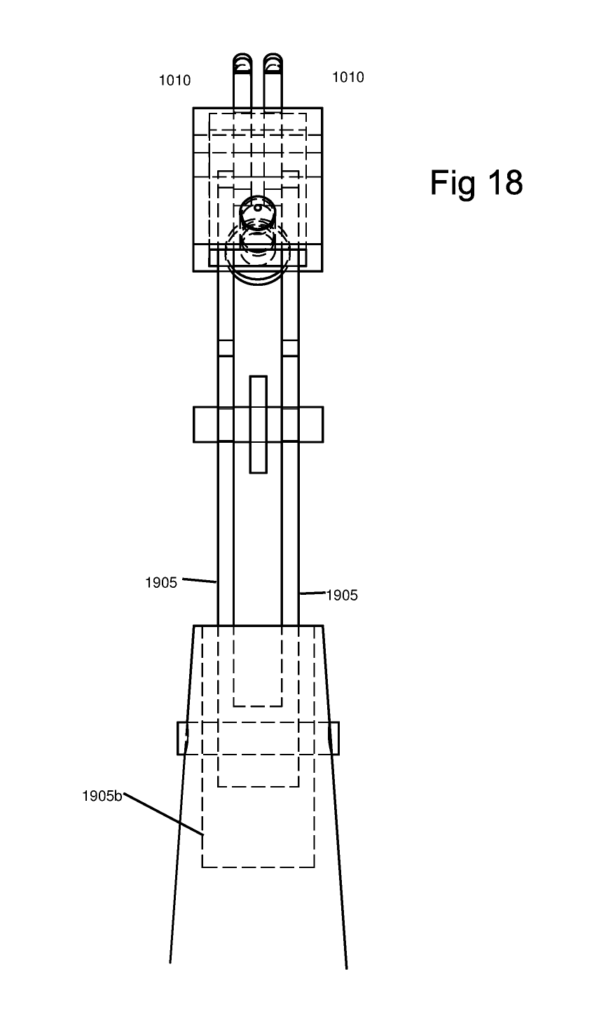

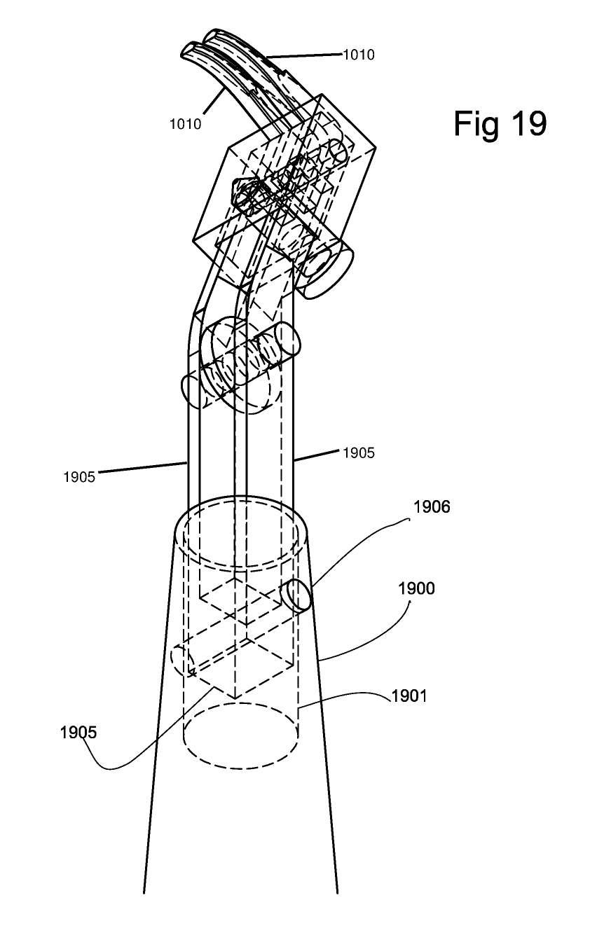

More details are shown in FIGS. 18 and 19 of the hinge joint and couplings (such as would implement 106, 206, 207 in FIGS. 1-2) within handle 1900 or similar handle-associated cylindrical housing 1901, where the proximal end portion(s) of extender(s) 1905 (that terminate distally with abutment prongs 1010) are pivoted on a pin 1906 disposed transversely to cylindrical housing 1901 and wherein the diameter of inner cavity 1905b within cylindrical housing 1901 is just large enough relative to the dimensions of the proximal ends of extenders 1905 (with distal prongs 1010) that some constrained pivotable movement is permitted via pin 1906. By this mechanism, the clinician may push linearly (along the longitudinal axis of the instrument) at or toward the adjacent tooth; and then, at the appropriate time in the restoration process by shifting the handle and cylindrical housing 1901 relative to proximal end portions of extenders 1905, toggle to a slight contra-angle direction, in order to apply an off-linear force. The change in direction from axial (along the longitudinal axis of the instrument handle) and then slightly off the axial to a slight oblique angle) is suitable to bring about desirable angles of attack by the clinician on the adjacent tooth (whether by torque or by orthogonal impact on the adjacent tooth) as (s)he negotiates the abutment of the matrix band against the adjacent tooth (whether pressing or pulling against the adjacent tooth). Although a cylindrical implementation has been shown, other geometries are possible and can bring about the desired range of movement. This range of movement (and translation of clinician's pull or push efforts on the instrument handle), coupled with the finger pressure on the finger pad acting directly axially on the stabilizing arm onto the adjacent tooth (ideally, its central groove), maximizes the mechanical forces on the matrix band onto the adjacent tooth for successful restoration.

Next is described a method for placing class II composite restorations in a box-type (proximal box) tooth preparation using a conventional Tofflemire matrix band and Tofflemire matrix band adjustable retainer, with the present invention of a band abutment instrument.

1. Wrap the Tofflemire matrix band around the (to be) treated tooth and tighten as much as possible with the adjustable retainer.

2. Secure band with wedge(s) and achieve isolation of the treated tooth.

3. Burnish the matrix band against the proximal surface of the adjacent tooth.

4. Apply etchant and rinse. Apply bonding agent and light cure.

5. Position, on a preliminary basis, the abutment instrument into the proximal box with the prongs in contact with the band, and adjust the width of the prongs to match the size of the desired contact area. Place stably the instrument's adjustment screw on the occlusal surface of the adjacent tooth and adjust the height of the instrument's stabilization screw (relative to the occlusal plane of the mouth) to optimally position the instrument's prongs occluso-gingivally (typically just gingival to the contour of the proximal face of the adjacent tooth, around the boundary of the gingival and middle third, with variance from tooth to tooth). Note that this preliminary position step can be performed earlier before step 1 if desired and if dentist has visual access of the adjacent tooth (either before step 1 or after step 3 when the height of the contour of the adjacent tooth becomes evident from the impressions of the burnished band). After this preliminary positioning and adjustment, remove the (adjusted) instrument.

6. Place small amount of flowable composite followed by packable composite and lightly condense the composite into the proximal box.

7. Loosen the band slightly (in the order of ¼ turn of the retainer nut or knob that controls the size of the band loop) for a bit of “slack”.

8. Place the (adjusted) instrument into the proximal box and press (e.g. with a finger) on the instrument's finger pad toward the occlusal surface of the adjacent tooth, to stabilize the instrument onto the occlusal surface of the adjacent tooth while pushing on the handle of the (adjusted) instrument to abut the prongs against the (initially, slightly slack) band to conform with the adjacent tooth for a tight distal contact (with the incisal and middle third of the adjacent tooth). For a tight mesial contact, the instrument would be pulled.

9. Light cure while maintaining the pressure with the abutment instrument.

10. Remove the abutment instrument and light cure.

11. Finishing including some or all of; fill the residual holes left in the composite by the abutment instrument, with flowable composite and cure again; add more composite as needed to restore the treated tooth to the desired occlusal height and light cure this extra layer; remove the band and wedge(s) and light cure the restoration from the buccal and lingual aspects; use finishing burs to remove excess composite and adjust height according to bite.

Light curing, etching, bonding and like conventional steps, are preformed according to their respective supplier's directions, and are easily adjustable by dental practitioners. For example, for a common light curing instrument and composites, the light curing is episodic in the order of 10 seconds each.

Many of the above steps are conventional and many are optional. Step 1 is the conventional wrapping and tightening—“Tighten the matrix as much as possible around the tooth” (e.g. Columbia University standard procedure http://www.columbia.edu/itc/hs/dental/operative/matrixband.html). The other steps are conventional with the inventive exceptions of several steps, as noted next.

Step 7 is the loosening of the band after the earlier “as much as possible” tightening of the band (of Step 1), the result of which is very counter-conventional, if not foolish outside of the context and teaching of the present invention; and Steps 5 and 8, being, respectively, the preliminary try-in and adjustment of the instrument, and the use of the adjusted instrument against the band and adjacent tooth to maximize the tightness of the inter-proximal contact.

In the above, both steps 5 (preliminary adjustment) and 7 (loosening of the band) are described above for convenience of expression as being part of one embodiment. Simpler embodiments are contemplated. For example, with the un-adjustable versions of the abutment instrument, step 5 is obviated; or with the versions of the abutment instrument where only the prong separation is adjustable, or where only the stabilizing arm is adjustable, step 5 is simplified accordingly. Un-adjustable versions include a kit or plurality of instruments whose prong separations are fixed and/or whose stabilizing arm is fixed relative to the remainder of the instrument. For another example, step 7 (the loosening of the band) can be skipped while proceeding to step 8 (pushing down on the instrument). For another example, step 5 (preliminary adjustment) is optional.

As explained earlier, the tight fit of the matrix band against the proximal surfaces of adjacent teeth, is critical to the success of Class II restorations and has been the subject of many instruments and techniques. Put simply, the pushing/pulling of a matrix band in the constrained environment of the oral cavity, remains a problem.

According to this invention, the best way to do this is to use (the occlusal surface of) the adjacent tooth as a point to stabilize any pushing/pulling instrument. That not only provides a stabilizing point proximate where the pushing/pulling must take place (i.e. between the treated tooth and the adjacent tooth) but also the occlusal surface is a relatively safe location (e.g. not near the gum which is vulnerable to trauma if the clinician's grip of the instrument slips).

The pin of the stabilizing arm is to be very stably located on the adjacent tooth, given a very constrained theatre of operation (the oral cavity of a patient) and the physical reality that a clinician's major muscular/skeletal infrastructure (e.g. hand, wrist, elbow) remains outside of the patient's oral cavity. To use an aeronautical analogy, that stabilizing arm/pin has to “land” very stably on challenging surfaces of the occlusal surface of the adjacent tooth. Not only the position (in 3-dimensional space) of the pin on the occlusal surface but also the angle that the pin imparts force on that position, should be both optimized for maximum stability as the clinician pulls/pushes relative to the matrix band. The following embodiment enhances that optimization by providing an automatic, self-adjusting mechanism to locate that optimal location and angle of the pin.

The occlusal surface of the adjacent tooth is as the clinician finds it. Instead of finding an ideal central groove which presents a single, robust, stabilizing location for a dental instrument to use (as a fulcrum point, base point or pivot point), there may be irregularities in the occlusal surface of many kinds and severities (for examples, of jagged edges, of an abrupt steepness of ridges, cusps, depressions and the like) that, for the particular, treated tooth (and its proximal box), greatly challenge the clinician. Such common irregularities makes it difficult for the clinician to securely and robustly establish a stabilizing fulcra point on the occlusal surface of the adjacent tooth (and thereby makes it more difficult, in the least for the present dental application of (Tofflemire or sectional) matrix bands, to establish the best, predictable proximal contact between the matrix band and the proximal box of the treated tooth).

Presented is another embodiment to assist on locating and securing the best fulcra point on the occlusal surface, by providing automatic adjustability in (at least) three dimensions—longitudinally (along the longitudinal axis of the instrument), laterally (i.e. orthogonally to that axis) and vertically (orthogonally to that axis downwardly towards the occlusal surface).

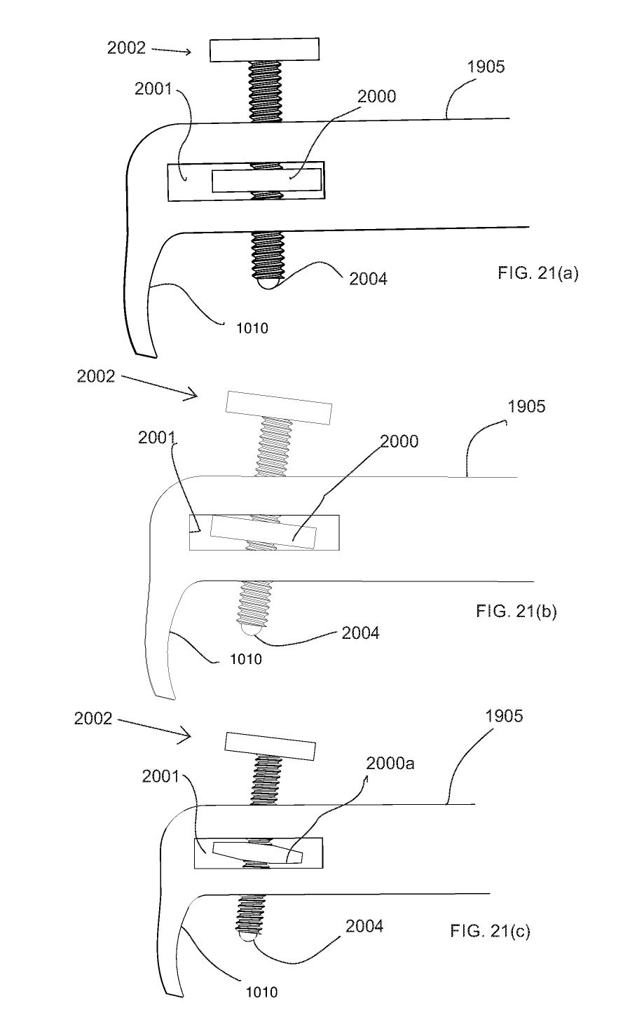

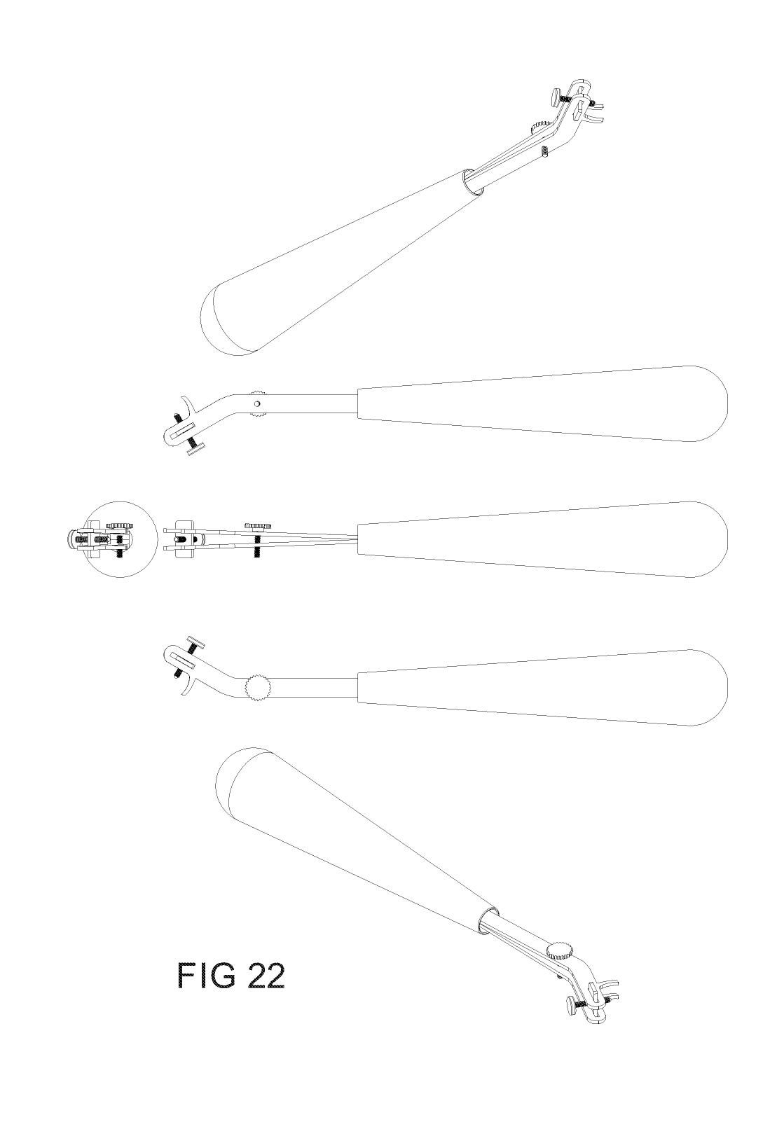

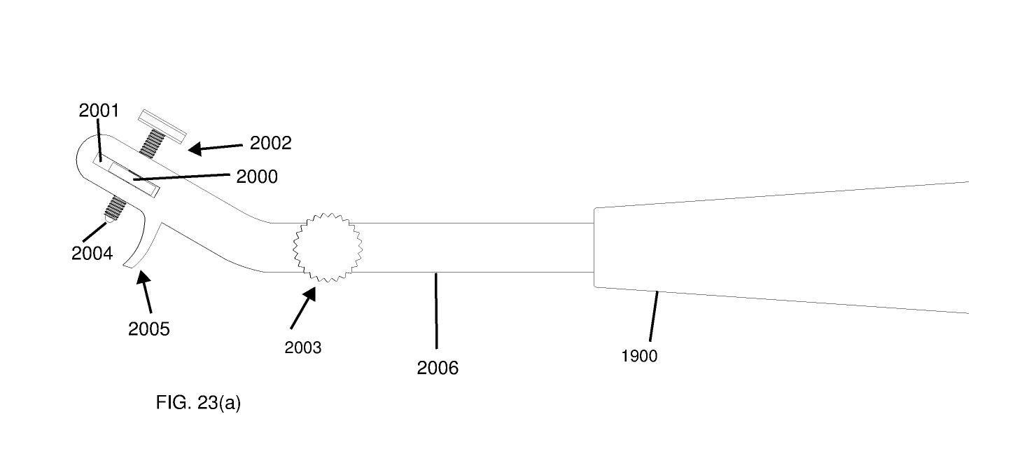

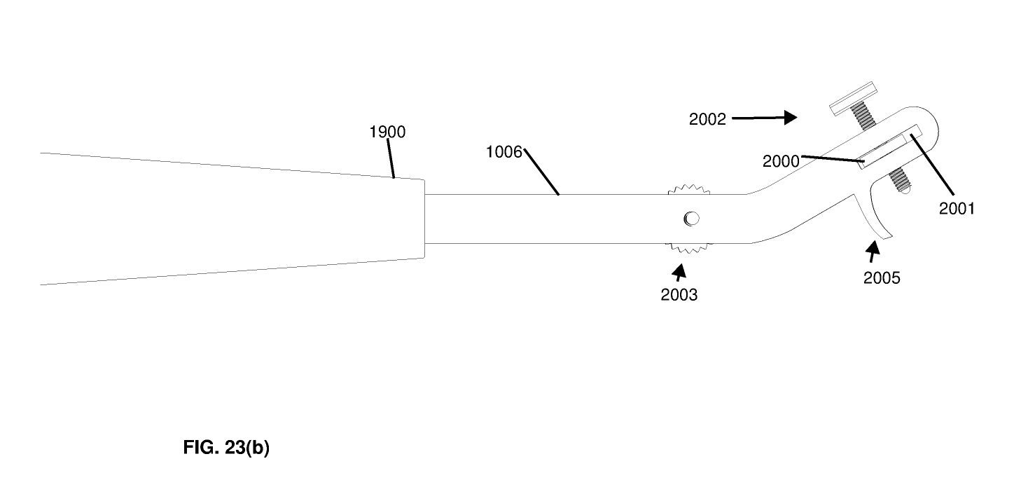

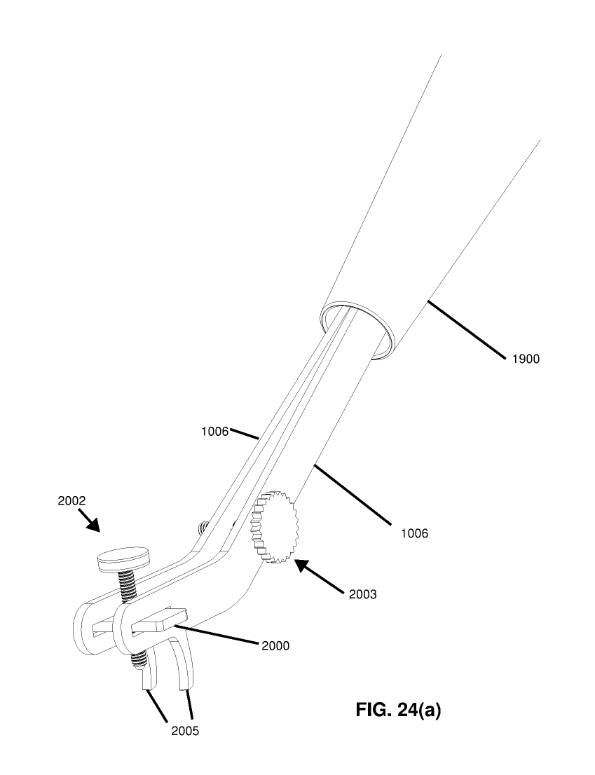

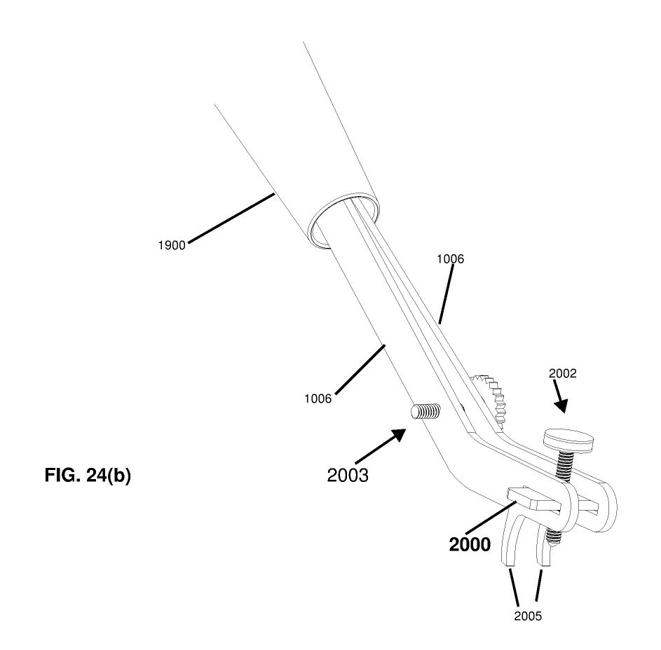

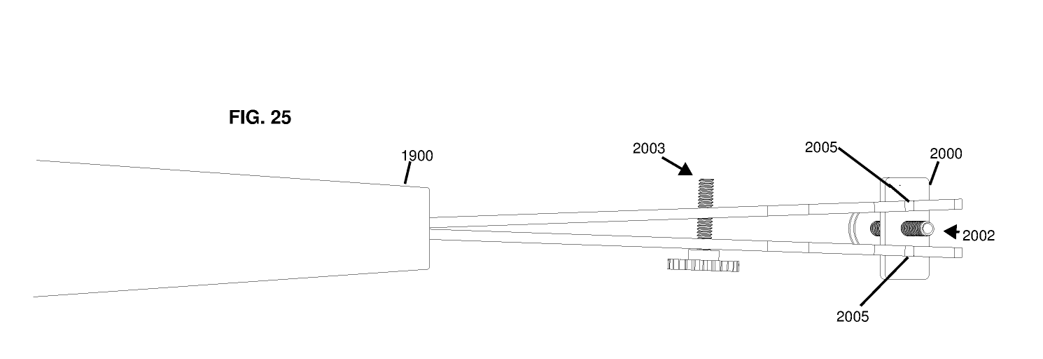

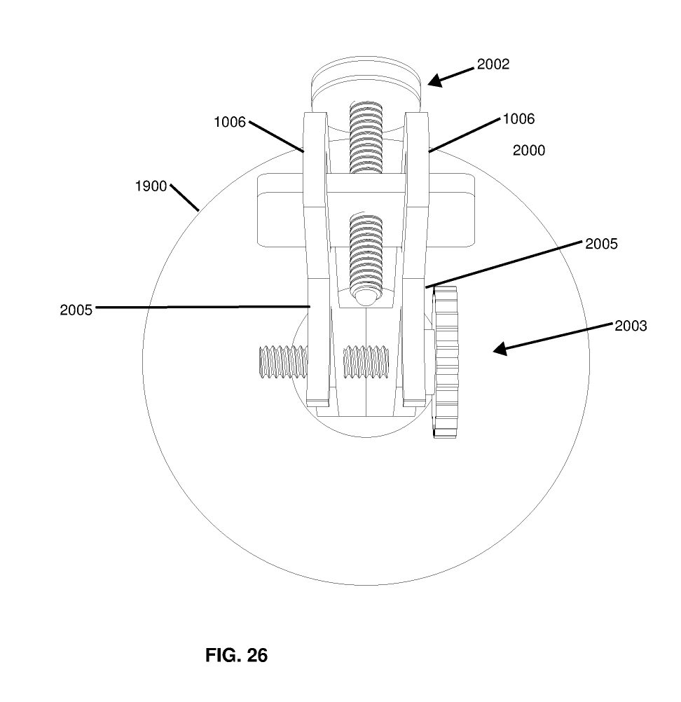

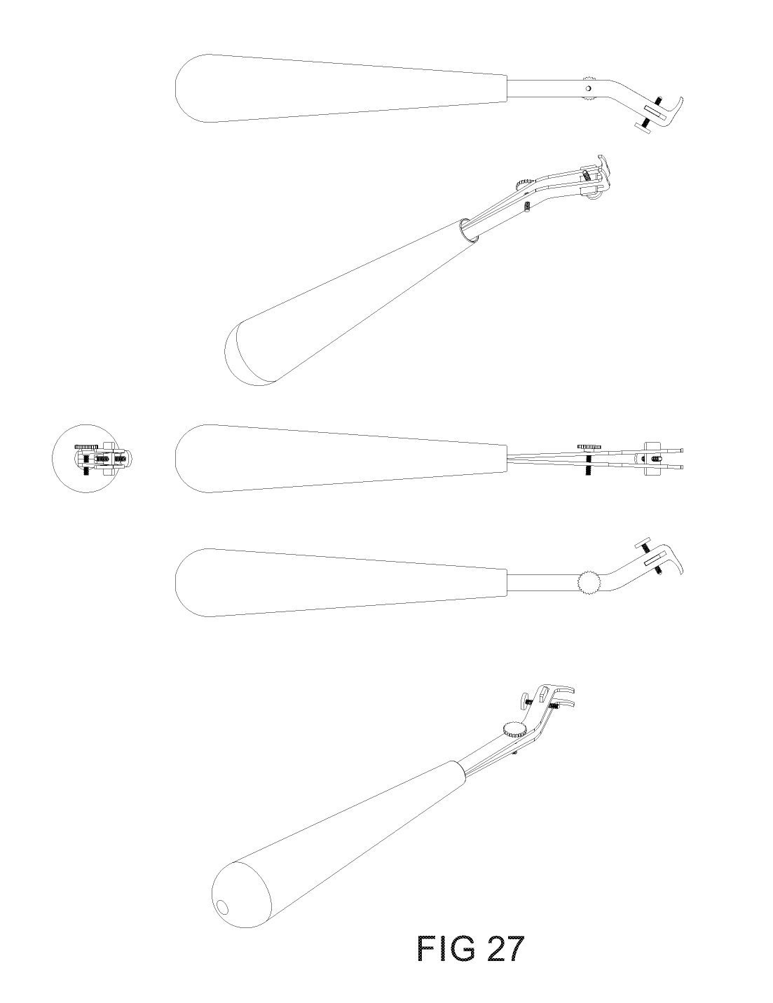

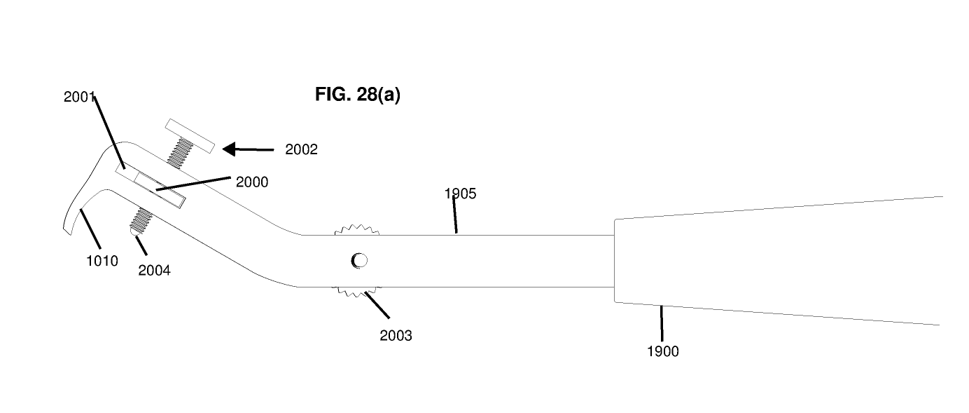

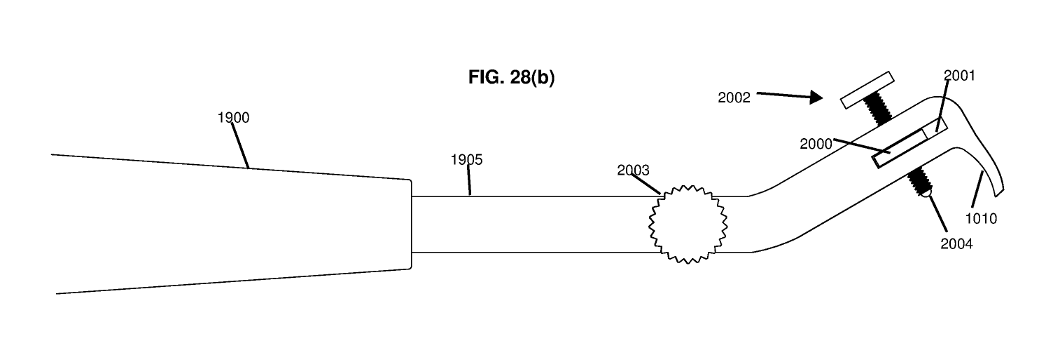

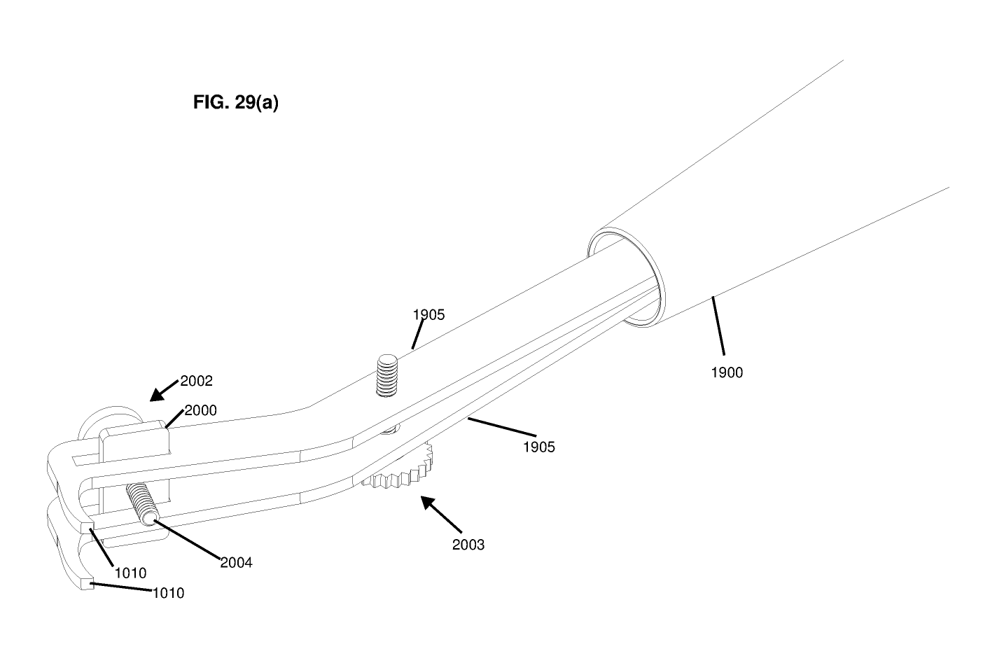

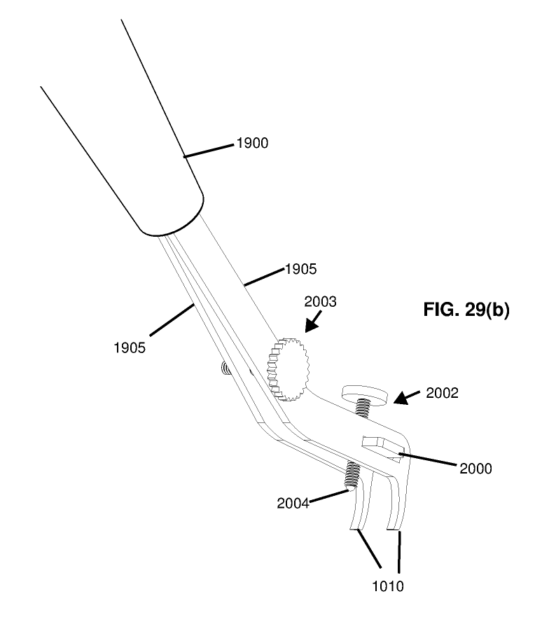

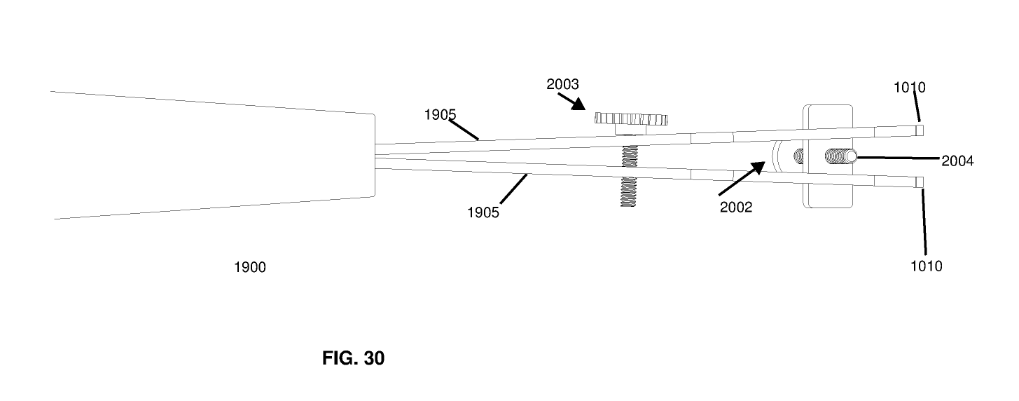

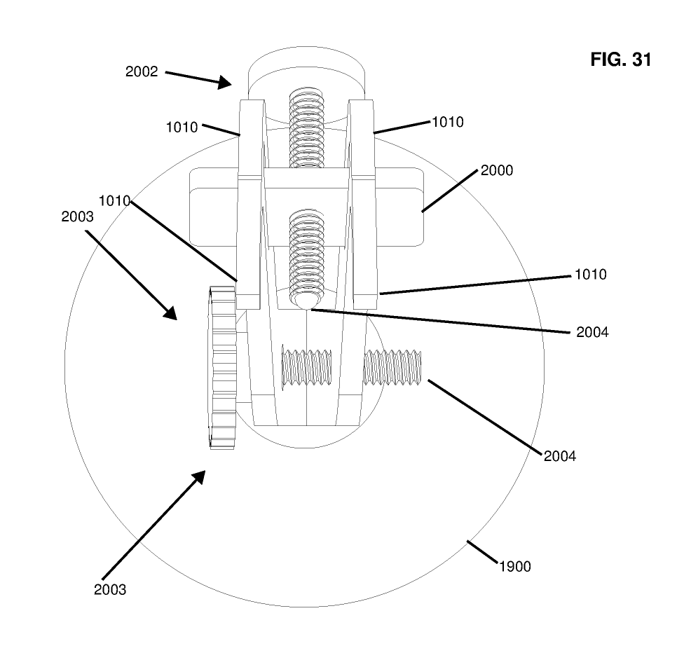

With reference to FIGS. 21-31, the key to the adjustability is shown in FIG. 21. FIGS. 27-31 are for the mesial restoration and are equivalent to FIGS. 22-26 for the distal restoration except for the location and orientation of the prongs (prong 2005 for distal; and prong 1010 for mesial), and accordingly, they are equivalent in relation to the operation of the slotted sled pin combination, as elaborated below. Explanation will be economically restricted to the mesial restoration version of FIGS. 22-26, and such explanation is equally applicable to the distal restoration versions mutatis mutandi.

Shown simply (in FIG. 21) and expressed simply, stabilizing arm pin 2002 is to be located on the occlusal surface of the adjacent tooth and carriage thereof is provided by sled 2000 that is freely movable (in all three fundamental directions) with respect to purposeful constraints and guides provided by slots 2001 of two extenders 1905 (herein, “slotted sled pin” combination).

Pin 2002 could be a threaded screw (or equivalent) with apical point 2004 (illustrated with an exaggerated curved surface) that (finally) rests on a point of the occlusal surface of the adjacent tooth. A “gross calibration” of the instrument is effected by the clinician—first, manually adjust the lateral separation of the prongs/extenders by evaluating the relevant part of the adjacent tooth, as limited by the narrowest width of the proximal box; and secondly, manually manipulate the instrument (and in particular, adjust the location of its stabilizing arm's screw's vertically oriented apical pin tip point 2004), in conjunction with the location of (the thus adjusted) prongs that abut the matrix band. The “gross calibration” will be particularized later.

After such “gross calibrations” (effected by the clinician visually and manually), the invention helps on the “fine tuning” by providing an automatically self-adjusting of the stabilizing arm's pin point 2004—the freedom of point 2004 (after “gross calibration”) to move (within limits appropriate for the oral cavity application) in all three directions is enjoyed simultaneously, and thus with a very modest amount of physical effort and time by the clinician, the instrument's pin tip 2004 will find the optimal location and angle to use as a fulcra point on the occlusal surface.

The “slotted sled pin” is freely movable in three fundamental directions (as seen in FIGS. 22-26)—(1) laterally (between two extenders 1905 or 1006), sled 2000 moving and transversing the two opposed extender slots 2001; (2) longitudinally (within the length of the extenders' slots 2001); (3) vertically (within the height of the extenders' slots 2001). In effect, with such movability in those three fundamental directions, the slotted sled pin is free rotationally, with the only constraints being the dimensions of the slots and their separation. By dimensioning the sled and the slots appropriate for the oral cavity application, it is possible to restrict freedom of movement to one or two directions (for example, providing no vertical gap between the sled and slot so that only longitudinal and lateral movement is permitted), and even then, the instrument and the slotted sled pin, will be automatically self-adjusting responsively to whatever occlusal surface irregularities scenarios that are confronted (and this invention considers all such automatic self-adjusting to be within its scope, even if with less than three dimensional self-adjustability). But the following explanation will explain the maximum freedom of self-adjustability.

FIG. 21 shows in enlarged representation, threaded pin 2002 with apical tip 2004, threadably secured within and through sled 2000 and is manually adjustable (similar to stabilizing arm/pin 210 and 1004 of other embodiments) (shown in finer scale representation in the other FIGS. 22-31). As in earlier embodiments (e.g. with stabilizing arm/pin 210 and FIG. 2 and associated explanations), pin 2002 is manually adjustable in sled 2000 to adjust the vertical position of apical tip 2004 relative to the prongs (e.g. in particular, the vertical position of tip 2004 relative to the horizontal plane of the bottom portion of the prongs). This provides the clinician's best but gross initial calibration of vertical Pin 2002 also may have a flat “finger-pad” top to later permit the clinician's digit to press vertically to secure the fulcra point. Apical tip 2004 is illustrated to have an idealized semi-spherical surface to maximize (smooth of rotable) negotiation of occlusal surface irregularities to find the “optimal” spot. In practice, tip 2004 may not have such an idealized surface, and accordingly the importance of the principles explained herein for locating the “optimal spot” for stability, becomes manifest.

Beyond the initial, gross calibration, there is provided self-adjusting for fine tuning, as explained next. FIG. 21 shows the configuration for mesial restoration (i.e. prongs 2005 in FIGS. 22-26); and the version for distal restoration would be identical except for the location and orientation of the prongs (i.e. with prongs 1010 in FIGS. 27-31).

FIG. 21 is not drawn to scale but with slightly exaggerated for clarity and ease of comprehension. FIG. 21(a) shows sled 2000 at the (instrument handle) proximate end of slot 2001. FIG. 21(b) shows sled 2000 in the longitudinal center of slot 2001, and rotated slightly. FIG. 21(c) shows sled 2000a, a version of sled 2000 of FIG. 21(b).

Prongs 1010 are at the distal portions of extenders 1905. Each extender 1905 is identical with longitudinal slot 2001 proximate a prong—longitudinally anterior for mesial restorations and posterior for distal restorations.

Prongs 1010 (or 2005) are to be abutted against the matrix band wrapped around the treated tooth (implicit in all matrix band restorations and shown only in FIG. 2 for economy of illustration), are set rigidly to the their extenders and the handle. Accordingly, once prongs 1010 (or 2005) are manually situated in the proximal box, it is the stabilizing arm's slotted sled pin that must be moved (and is movable) to stabilize the instrument and the anticipated force applied to the prongs against the matrix band against the adjacent tooth.

In FIGS. 22-31, adjustable knob 2002 is similar to knob mechanism 1002 and threaded pin 1003 transversing the two extenders (as shown in other drawings), and is manually manipuable to adjust the lateral separation of the extenders and their respective prongs.

Sled 2000 is slidably engaged within two extender longitudinal rectangular slots 2001 which are opposedly aligned in the lateral direction, and which are dimensioned to allow some movement along the longitudinal axis of the instrument. The opposed extender longitudinal slots 2001 define physically a transverse “lateral slot” within which the sled/pin is movable between the two prongs/extenders. The central pin provides Slots 2001 (shown with more clarity in FIG. 21 than in FIGS. 22-31) shows a very small clearance or gap between sled 2000 and the ceiling/floor of slots 2001. Sled 2000 is generally longitudinally dimensioned so that when engaged within, and transversing, two opposed slots 2001, protrudes enough so that when the lateral separation of extenders and associated slots 2001 is adjusted (e.g. by knob 2002 during “gross calibration”), sled 2000 will is not movable to disengage from any of slots 2001.

FIGS. 21-31 show some relative dimensions of sled 2000 and two laterally opposed extender slots 2001, each slot extending longitudinally along the instruments main axis of force for distal and mesial restoration, to be viewed with the following explanations.

Sled 2000 is a relatively longitudinal, thin slab that transverses the extenders and their respective slots 2001. Slot 2001 is generally longitudinal, reflective of the main actions of the clinician with the instrument—the mesial/distal Class II restorations generally call for a “pulling in” or “pushing out” force by the clinician with the instrument relative to the oral cavity.

Relative to the (vertical, horizontal and longitudinal) dimensions of slot 2001, sled 2000 is dimensioned in the three fundamental directions as follows:

(1) in height to leave a small vertical gap within slot 2001 when inserted therein;

(2) sled 200 is also dimensioned in another direction to permit sliding along the longitudinal length of both extender slots 2001, which direction is the main axis of pulling/pushing of the instrument for restoration; and

(3) dimensioned in one horizontal direction (its “length”, orthogonally oriented to the main longitudinal axis of the instrument) so that when inserted within two opposed slots 2001 of extenders, each opposed end parts of sled 2000 protrude beyond the extenders. Screw pin 2002 (centrally located in sled 2000) provides the constraint to prevent sled 2000 from escaping either of slots 20001. Furthermore, even when pin 2002 is rotated (e.g. during gross calibration by clinician), sled 2000 has been dimensioned long enough that it cannot (even if rotated) escape and fall out from the opposed slots 2001. Thus, sled 2000 is securely engaged and movable within opposed slots 2001.

Note that the above-described three-dimensional freedom of movement, permit rotation of pin/tip/sled in a way that is congruent with the three main motions of {pitch, yawl, roll} of a boat on the water with waves. As pin 2000 tip 2004 negotiates the irregularities of the occlusal surface of the adjacent tooth, sled 2000 automatically self-adjusts within slots 2001, like a boat negotiates the confronted waves with motions of {pitch, yawl, roll}. With such self-adjustment of sled 2000 within (the constraints of) slots 2001, in conjunction with the firm force of the clinician on the instrument to find a stable location (for subsequent forced abutment of the prongs on the matrix band to expand the band against the adjacent tooth).

FIG. 21(a) is an idealized, enlarged side view of the pin/sled within a slot. The drawings FIGS. 22-31 in respect of the pin/sled/slot configuration are acceptable but FIG. 21 is exaggerated in scale and relative dimensions for ease of comprehension. FIG. 21(a) shows a vertically gap (actually two gaps—an upper gap between top of sled 2000 and the ceiling of slot 2001) and a lower gap between the bottom of sled 2000 and the bottom of slot 2001). The stabilizing arm/pin/sled is rigidly threaded, so the combination is rotatable (within constraints), as best seen (in exaggerated relative dimensions) in FIG. 21(b).

The rectangular sled/slot geometric configuration shown in FIGS. 21(a), 21(b) and others, is not the only geometric configuration. Other geometric surfaces of the sled may be used to increase freedom of (self)adjustability. For example, sled 2000a with champferred end portions, is shown in FIG. 21(c)—the additional space within slot 2001 because of the smaller sled end portions, gives pin 2002 and tip 2004 more range of motion with more possibilities to contact on the best location on, and best angle at, the collusal surface of the adjacent tooth. Other geometries of sled and/or of slots are worthy—ellipsoid or ovoid (ie. with curved end portions) may facilitate freedom of (self)adjustment by providing more space for rotations of the sled.

Accordingly, this embodiment's stabilizing arm/pin/tip is automatically adjustable (in at least three directions), responsively immediately to the particulars of the occlusal surface of the adjacent tooth as the clinician tries to secure the best fulcra point contact on the occulusal surface. These three directions, as follows.

1. Vertically (relative to the prongs) within the slot. After the clinician's manual manipulation of threaded pin 2002 (such as arm 104 and pin 210 and FIG. 2), sled 2000 floats vertically within slot 2001.

2. Laterally within two extenders's opposed slots.

3. Longitudinally—along the longitudinal axis of the instrument.

The clinical procedure described above (in conjunction with the conventional procedure modified by the inventive changes in the loosening), is modified slightly with the automatically self-adjusting stabilizing arm/pin described in association with FIGS. 21-31. The modified procedure becomes:

1. preparing a tooth for Class II restorative procedure (including the establishment of a proximal box with a side wall opening (onto the adjacent tooth) to be restored).

2. applying a matrix band (e.g. sectional or Tofflemire) to the treated tooth and placing wedge(s) as appropriate.

3. burnishing the band against the adjacent tooth.

4. placing the instrument within the proximal box to face the adjacent tooth and adjusting its configuration (of prongs and of stabilizing arm/pin/tip and of their spatial relationships with each other) to an optimal configuration by adjusting according to the following steps:

step (a) establishing the appropriate prong separation (by clinician's manipulating the horizontal screw 2003 (and thereby the separation of extenders 1905 and prongs 1010 in FIGS. 27-31, for mesial restoration, the separation of extenders 1006 and prongs 2005 in FIGS. 22-26 for distal restoration, based on a clinician's visual evaluation of the contour of the relevant buccal-lingual width of the adjacent tooth, with maximum separation being the narrowest width of the proximal box side wall opening); and then performing incrementally (and iterating, if necessary) steps (b) and (c) as follows:

step (b) adjusting the vertical position of the (thus separated but vertically in tandem) prongs relative to the contour of the relevant buccal-lingual portion of the adjacent tooth (by, for example in FIGS. 22-26 (distal restoration), manipulating the vertical screw 2002 tip 2004 resting on the occlusal surface of the adjacent tooth, and in FIGS. 27-31 (mesial restoration), with details in FIG. 21) based on the clinician's visual evaluation of the contour of the relevant buccal-lingual portion of the adjacent tooth and the position of the prongs relative thereto—e.g. the prongs may be a bit “too high” or “too low” for maximum effective contact of the prongs with the relevant portion of the band, and then the clinician turns (a bit) screw pin 2002 clockwise or counter-clockwise, for a better expected contact); and

step (c) incrementally manipulating with the stabilizing arm (with the step (b) adjusting vertical screw 2002 (and its tip 2004) being located on the occlusal surface of the adjacent tooth) with longitudinal force (either pulling/pushing for mesial/distal restoration) to “find” the optimal fulcra stabilizing point (i.e. try to locate and establish the optimally stable fulcrum on the occlusal surface of the adjacent tooth for screw tip to rest on and be pulsed/pushed on.

If step (c) results in a placing of the instrument that remains stable under clinician's force, then the optimal configuration has been achieved. If step (c) results are not satisfactory, i.e. not sufficiently stable because under force, the instrument “slips” because the stabilizing arm's pin tip has slipped on the occlusal surface), then steps (b) and (c) are iterated (i.e. the step (b) vertical screw is slightly adjusted upwardly or downwardly, and step (c) is repeated to “find”/confirm, etc.).

Adjustment step (a) is a function of (within lateral separation limits) the buccal-lingual contour width of the adjacent tooth. Adjustment step (b) is a function of, and motivated by, the vertical position of the prongs for sufficient contemplated proximity/contact with the contour of the relevant buccal-lingual aspect of the adjacent tooth). Adjustments steps (a) and (b) may be seen as “gross calibration” of the configuration of the instrument because they are (conventional and are, at least partially, visual, “eyeball”) evaluations and adjustments by the clinician. And adjustments (b) and (c) together may be seen as “fine tuning”. Adjustments (b) and (c) may be incrementally iterated when the single performance of those steps fails, to the satisfaction of the clinician, to locate the best point for the stabilizing arm's screw tip in particular, and establish the instrument configuration, generally).

It is the combination of adjustments (a), (b) and (c) which results in the “optimally configured” instrument”. In other words, step (c) will confirm that the step (b) adjustment (vertical) is satisfactory (because stability is achieved) or will prompt the clinician to perform step (b) again (because the instrument becomes unstable when stabilizing arm is pressed on the occlusal surface). Eventually the combination of adjustments (a), (b) and (c) will result in the optimal configuration of the instrumen.

5. verifying the reproducibility of the (optimally configured) instrument, by removing and repositioning it within the proximal box and with the stabilizing arm/pin on the adjacent tooth's occlusal surface to confirm that the prongs are configured (i.e. the vertical screw (step b), and thereby the screw tip is positioned for optimal contact with the coronal proximal aspects of the adjacent tooth, and in particular, the occlusal surface thereof). As necessary, further iterations of sub-steps 4(b) and 4(c) are conducted to achieve the “optimal configuration”.

6. etching and bonding the prepared tooth.

7. placing sufficient composite in the proximal box of the tooth preparation so that effective contact with the prong-contacted band is effected and that upon completion of the restoration process, the cured composite (and restored tooth) has effective contact area with the adjacent tooth.

8. placing the (optimally configured) instrument within the tooth preparation as in step 4, such that the prongs are inserted into the composite and positioned against the band while the stabilizing arm/pin stably fulcrums against the occlusal surface of the adjacent tooth at the location thereof identified (in step 4).

9. applying a force against the band using the (optimally configured) instrument (by pushing against the adjacent tooth for distal restorations or pulling for mesial restorations), while keeping the stabilizing arm stably engaged in contact against the occlusal surface of the adjacent tooth.

10. while the force (of step 9) is applied against the adjacent tooth, an initial cure of the composite is achieved.

Manipulable articulations (such as extenders 1905 pivoting on transverse pin 1906 in FIG. 19 and flexible/rotatable coupling 106 in FIG. 2) and conventional equivalents or mechanical analogues, provide for the clinician, in conjunction with the inventive stabilizing arm/pin/tip, additional leverage at a distance from the treated tooth, to translate his personal (limited bodily) leverage into desired locations and angles within the oral cavity to locate the “optimal spot” for the stabilizing arm as the clinician presses (or pulls) the prongs against the matrix band and adjacent tooth during restoration.

When using a sectional matrix band (instead of a Tofflemire band), the preceding explanations are applicable mutatis mutandi with exceptions obviously flowing from the use of a sectional band without a Tofflemire retainer—(there is no tightening or loosening of the band, there is use of bi-tine rings and the like); otherwise the (adjusted) instrument can be used as described above.

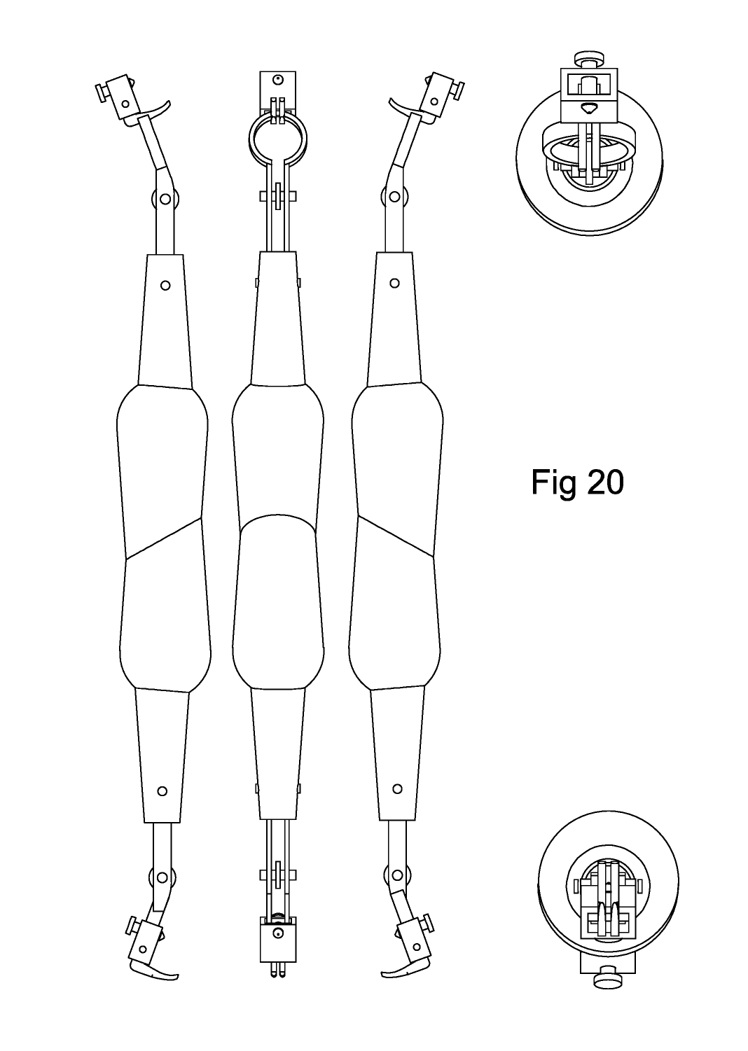

The tool portions of the instrument may be formed conventionally with the handle. Conventional examples include: bayonet attachment, snap-fit, threaded the free end of handle shank to threadably mate with the correspondingly threaded hole of the handle end. Thus, the tool portions of the instrument may be manufactured for easy attachment and detachment. Thus, provided to the clinician is a plurality of differently sized (dependent on the clinician's evaluation of the restoration task and oral environment) can chose stabilizing arms that are at preset vertical lengths. And prongs which are at preset separations. Also, as seen in FIGS. 5 and 20, both the mesial and distal tool portions are provided in a single instrument.

The instrument's said prongs separation adjustability may be effected by any mechanism that translates rotary motion into linear motion (or vice versa, directly or indirectly) that controls the separation. Hinge screw, scissors and forceps-like mechanisms are well known. For example, knurled rotary knob 1002 in FIG. 10(b), is a conventional knob threadably interposed between two prong extenders 1006, and by the clinician's thumb interacting with knob 1002 while holding the instrument in place in the proximal box, the optimal prong separation can be immediately and easily achieved.

Generally herein, the extenders, sleds, pins, knobs, prongs and related components described herein, may be made conventionally of metallic or synthetic materials with properties of rigidity and elasticity that are usefully common in the oral cavity environment, in particular, and the oral health industry, generally.

The material used for manufacturing the instrument can be conventionally metallic. Also, advantageously (but not required for this invention), optically transparent, synthetic material to allow passage of light to pass through for curing the composite. For all embodiments, selection of materials for formation of the assemblies will depend on several factors. In all cases, materials selected must be durable enough to withstand the pressures (e.g., grasping, pushing, pulling) applied throughout the system during a procedure. Furthermore, the materials utilized should be malleable enough to be formed into the desired shapes and orientations. If an embodiment requires a deformable member, the material used to form that member should be flexible enough to provide the desired deformation while remaining durable enough to withstand the pressures applied. If an assembly or a sub-portion thereof is intended to be of a disposable, one-use nature, then a reliable but inexpensive material (e.g., plastic) may be used in production. If an assembly or a member is intended to be of a re-usable nature, then a durable material (e.g., stainless steel), capable of withstanding repeated sterilization procedures, may be used in production.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Also, as used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Thus, specific devices and methods of restoring teeth have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

1. A dental instrument for assisting in the restoration of a patient's tooth (“treated tooth”) and another tooth that is posteriorly adjacent to the treated tooth (“adjacent tooth”), the treated tooth having a proximal box of width proximate adjacent tooth (“proximal box width”), in conjunction with a matrix band, comprising:
(a) an elongate handle for hand gripping, having first and second opposed end portions;
(b) a first tool portion at said first handle end portion,
said first tool portion including (i) a first abutment portion and (ii) a first stabilizing arm that extends longitudinally posteriorly of said first abutment portion when the instrument is located within the proximal box of treated tooth, for stabilizing contact with the occlusal surface of the tooth posteriorly adjacent to the treated tooth.

2. The instrument of claim 1, wherein said first abutment portion includes a first condenser.

3. The instrument of claim 2, wherein said first condenser includes first and second prongs, extending vertically (and generally orthogonal to the longitudinal axis), generally parallel, laterally spaced apart, first separation to present an abutment portion surface with an effective lateral width less than said proximal box width.

4. The instrument of claim 1, further comprising, a second tool portion at said second handle end portion.

5. The instrument of claim 4, wherein said second tool portion includes a second abutment portion and a second stabilizing arm that extends longitudinally anteriorly of said second abutment portion when the instrument is located in the proximal box, for stabilizing contact with the tooth anteriorly adjacent to the treated tooth.

6. A dental instrument for assisting in the restoration of a patient's tooth (“treated tooth”) and another tooth that is posteriorly adjacent to the treated tooth (“adjacent tooth”), the treated tooth having a proximal box of width proximate adjacent tooth (“proximal box width”), in conjunction with a matrix band, comprising:
(a) an elongate handle for hand gripping, having first and second opposed end portions;
(b) a first tool portion at said first handle end portion.
said first tool portion including (i) a first abutment portion and (ii) a first stabilizing arm that extends longitudinally anteriorly of said first abutment portion when the instrument is located within the proximal box of treated tooth, for stabilizing contact with the occlusal surface of the tooth anteriorly adjacent to the treated tooth.

7. The instrument of claim 4, wherein said second tool portion including a second abutment, wherein said second abutment portion includes a second condenser.

8. The instrument of claim 7, wherein said second condenser includes two, parallel vertically extending prongs with a width less than the width of the portion of the proximal box closest to the adjacent tooth.

9. The instrument of claim 7, wherein said second condenser includes two, parallel prongs with a second separation that is different than said first condenser prong separation.

10. The instrument of claim 3, wherein each said prongs is tapered vertically.

11. The instrument of claim 3, wherein each said prong is curved to maximize conformance with the convex contour (incisal to middle third) of adjacent tooth; and includes (metallic or plastic) differently curved tips detachable/rotatable to the shank of the prong.

12. The instrument of claim 3, wherein said curved prongs are rotatable about a vertical axis orthogonal to occlusal surface of the treated tooth.

13. The instrument of claim 3, wherein stabilizing arm stabilizing contact on the occlusal surface of the adjacent tooth is effected by a stabilizing arm fulcral point that is automatically self-adjusting in response to the contours of the occlusal surface contacted.

14. The instrument of claim 3, wherein each prong continues so that there are two stabilizing arms.

15. The instrument of claim 3, wherein said first tool end portion has first and second longitudinal extenders that are laterally spaced apart, that couple said first and second prongs to said handle.

16. The instrument of claim 19, wherein said extenders are adjustable in their space-apartedness to adjust the width of said first arm abutment portion.

17. The instrument of claim 1, wherein said first stabilizing arm fulcra point is adjustable vertically with respect to the height of said first stabilizing arm abutment portion, to provide a stabilizing contact with the occlusal plane of the posteriorly adjacent treated tooth.

18. The instrument of claim 19, further comprising a sliding frame where two prongs are slidable horizontally with respect to each other.

19. The instrument of claim 1, wherein said first tool portion has a first, attachable and detachable mechanism with a corresponding mechanism part of said first handle end, wherein said first tool portion has a second, attachable/detachable mechanism on the opposed end, and i.e. push becomes pull device by detaching the tool portion and reversing it and re-attaching handle.

20. The method of restoring with composites and a Tofflemire band retainer, whereby after tightening the band around the treated tooth, the band is then loosened and the instrument of claim 1 is used to abut the band against the convex contour of the posteriorly adjacent tooth.
